(19) United States
(12) Patent Application Publication
(10) Pub. No.: US 2006/0056886 A1
(43) Pub. Date: Mar. 16, 2006

(54) Image fixing device, image recording apparatus equipped with the same, and image fixing method

(75) Inventors: Chikashi Ohishi, Shizuoka (JP); Mutsumi Naniwa, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/226,290

(22) Filed: Sep. 15, 2005

(30) Foreign Application Priority Data
Sep. 15, 2004 (JP) 2004-268327
Sep. 21, 2004 (JP) 2004-272753

(51) Int. Cl. G03G 15/20

(52) U.S. Cl. 399/322; 399/328

(57) ABSTRACT

The image fixing device includes a fixing roller pair by which a recording medium having an image formed thereon is nipped and conveyed to fix the image, and a gripping/conveying unit which includes a gripping portion for gripping a leading edge of the recording medium and which conveys the recording medium between two fixing rollers while gripping the leading edge of the recording medium. In this device, at least one of the two fixing rollers of the fixing roller pair has a recess receiving the gripping portion, and is set such that when the leading edge of the recording medium gripped by the gripping portion is nipped between the two fixing rollers, the gripping portion is received by the recess. Alternatively, the device includes a roller moving unit for moving at least one of the two fixing rollers. The roller moving unit brings the two rollers of the fixing roller pair out of contact with each other before the gripping portion gripping the leading edge of the recording medium passes between the fixing rollers, and brings the fixing rollers into contact with each other after the gripping portion has passed between the fixing rollers.

### BACKGROUND OF THE INVENTION

The present invention relates to an image fixing device, an image recording apparatus equipped with the same, and an image fixing method, and, more specifically, to an image fixing device which performs image fixing with heat by bringing a heating member into contact with an image formed on a recording medium with colorant particles (colored fine particles) containing pigment and resin by using an ink jet printer, an electrophotographic copying machine or printer, a printing machine, or the like, an image recording apparatus equipped with such an image fixing device, and an image fixing method.

An image fixing device adopting a heat roller fixing system is generally used to fix to a recording medium an image formed with colorant particles (colored fine particles) containing pigment and resin by using an image forming device, such as an ink jet printer, an electrophotographic copying machine or printer, or a printing machine. In the heat roller fixing system, a fixing roller is brought into contact with the colorant on the recording medium for heating and applying a pressure, thereby fixing an image formed on the recording medium. In this image fixing system, the fixing roller is brought into contact with the image portion immediately after the image formation, whereby a satisfactory heat efficiency is attained, and quick image fixing is possible. Conventionally, as the fixing roller mentioned above, a silicone rubber roller which exhibits a satisfactory heat resistance is widely used.

What should be noted here is that images formed by an image forming device, such as an ink jet printer, are high-definition images, and that their high image quality should not be impaired during the fixing process. Further, to prevent a reduction in image density, it is desirable, in many cases, to make the finish image surface as smooth as possible to thereby suppress surface reflection as much as possible. Thus, generally speaking, it is desirable to use a fixing roller (heating roller) with a smooth surface.

However, when fixing an image by an image fixing device based on the heat roller fixing system, the recording medium is likely to stick to the fixing roller, causing a defective conveyance of the recording medium, such as jamming. In particular, when a silicone rubber roller is used as the fixing roller, there is a marked reduction in the separation property of the recording medium due to the adhesiveness of the silicone rubber roller. Thus, to attain a further increase in the processing speed and high reliability of the image fixing device, it is necessary to solve the problem of sticking.

To prevent this sticking of the recording medium to the fixing roller, there has been conventionally used a method in which a releasing agent, such as silicone oil, is applied to the surface of the fixing roller. However, to prevent sticking by this method, it is necessary to apply a large amount of silicone oil to the fixing roller. When an image is fixed by using the fixing roller to which a large amount of silicone oil is thus applied, there are generally involved new problems, such as unevenness in image and a reduction in gloss.

JP 2002-264297 A discloses an ink fixing device in which ink containing a resin and a solvent compatible with the resin is transferred to a recording medium, and then an ink fixing member exhibiting a swelling property with respect to the solvent contained in the ink, such as a silicone roller or a silicone belt, is brought into contact with the surface of the recording medium, thereby curing the ink on the surface of the recording medium, wherein an ink fixing device having a separation mechanism composed of a Teflon (registered trademark) blade or the like is provided in the vicinity of or so as to be in contact with the ink fixing member.

JP 2002-120953 A discloses a printer equipped with a silicone rubber sheet feeding roller which conveys a recording medium by rotating while being in contact with the recording medium, wherein the outer peripheral portion of the roller is coated with an RTV silicone rubber obtained by mixing polyamide resin composition powder having an amino group at the end with a vulcanizer having an ion group or an acid anhydride group, and the surface roughness in terms of R_{y} (maximum height) is set at 1 to 600 μm, thereby enhancing the dimensional accuracy, wear resistance, and non-adhesiveness of the roller.

As described above, the image fixing device disclosed in JP 2002-264297 A has a separation claw as the separation mechanism for separating the recording medium from the fixing member, such as the fixing roller or the fixing belt. In relation to the image forming device of JP 2002-264297 A, there are disclosed a case in which this separation claw is arranged so as to be in contact with the fixing member, and a case in which it is arranged in the vicinity of the fixing member without being in contact therewith.

In the case in which the separation claw is arranged so as to be in contact with the fixing member, this separation claw forcibly separates the recording medium which is conveyed while being in contact with the fixing roller, at the point of contact between the separation claw and the fixing roller. Thus, as long as the separation claw is held in contact with the fixing roller, there is a fear of the separation claw damaging the surface of the fixing roller. Thus, in the method in which the separation claw is held in contact with the fixing member, there is a fear of generation of problems, such as generation of unevenness in image in the portion corresponding to the flaw on the fixing roller and a reduction in the service life of the roller.

In the case in which the separation claw is arranged in the vicinity of the fixing member without being in contact with the fixing member, the leading edge of the recording medium, which is conveyed while undergoing image fixing by the fixing member, is slightly separated due to the curvature of the fixing roller after passing the fixing portion of the fixing roller, so that the recording medium is separated from the fixing member by bringing the leading edge of the recording medium into contact with the separation claw. In this case, there is a fear of the image formed on the recording medium being damaged due to the contact of the image forming surface of the recording medium with the separation claw.

According to JP 2002-120953 A, there is used a silicone rubber roller whose surface roughness in terms of R_{y} (maximum height) is set at 1 to 600 μm, thereby enhancing the non-adhesiveness of the roller and making it possible to provide a sheet feeding roller with high separation property. However, to form an image of satisfactory quality, it is more desirable to use a roller with a smooth surface than a roller with such surface roughness as the fixing roller. When fixing is effected by using a roller with such surface roughness, a satisfactory image may not be formed.

On the other hand, as stated above, in the case in which, in order to form an image of satisfactory quality, a fixing roller with a smooth surface, or a paper sheet (recording medium) with a smooth surface like art paper or coated paper is used, sticking of the sheet to the fixing roller occurs to a marked degree. Further, the thinner the recording medium, the lower the rigidity thereof, and the more likely it is for the sheet to stick to the fixing roller. Further, there is the problem of fluctuation in separation property depending on the speed at which the recording medium is conveyed.

### SUMMARY OF THE INVENTION

The present invention has been made in view of the above problems in the prior art. It is a main object of the present invention to solve the above problems in the prior art and to provide an image fixing device having satisfactory conveying means capable of reliably separating the recording medium from the fixing roller and conveying the recording medium independently of the conveying speed, the fixing conditions, such as the temperature and pressure at the time of image fixing, and the quality and shape of the recording medium, such as the kind of paper (the kind and nature of the paper), and the thickness of the paper sheet, an image recording apparatus equipped with such an image fixing device, and an image fixing method using the same.

Another object of the present invention is to provide an image fixing device capable of heat-fixing a high-definition image without impairing the image quality thereof or reducing its gloss, an image recording apparatus equipped with such an image fixing device, and an image fixing method using the same.

In order to attain the main object as well as the other object described above, a first aspect of the present invention provides an image fixing device which fixes an image formed on a recording medium to the recording medium, comprising: a fixing roller pair which has two fixing rollers in contact with each other and in which the image is fixed to the recording medium being nipped between and conveyed by the two fixing rollers; and gripping/conveying means which includes a gripping portion for gripping a leading edge of the recording medium and which conveys the recording medium between the two fixing rollers of the fixing roller pair while gripping the leading edge of the recording medium by the gripping portion, wherein at least one of the two fixing rollers has a recess receiving the gripping portion, and wherein at least one of the two fixing rollers is set such that when the leading edge of the recording medium gripped by the gripping portion of the gripping/conveying means is nipped between the two fixing rollers of the fixing roller pair, the gripping portion of at least one of the two fixing rollers is received by the recess.

Here, preferably, the two fixing rollers of the fixing roller pair are arranged vertically, and the recess is formed solely in one of an upper fixing roller or a lower fixing roller of the fixing roller pair, or the recess is formed in each of the two fixing rollers.

And, in order to attain the main object and the other object described above, a second aspect of the present invention provides an image fixing device which fixes an image formed on a recording medium to the recording medium, comprising: a fixing roller pair which has two fixing rollers brought into and out of contact with each other and in which the two fixing rollers are brought into contact with each other to cause the recording medium to be nipped between and conveyed by the two fixing rollers to fix the image to the recording medium; roller moving means for moving at least one of the two fixing rollers so that the two fixing rollers of the fixing roller pair are brought into or out of contact with each other; and gripping/conveying means which includes a gripping portion for gripping a leading edge of the recording medium and which conveys the recording medium between the two fixing rollers of the fixing roller pair while gripping the leading edge of the recording medium by the gripping portion, wherein the roller moving means brings the two fixing rollers of the fixing roller pair out of contact with each other before the gripping portion gripping the leading edge of the recording medium passes between the fixing rollers of the fixing roller pair, and brings the two fixing rollers into contact with each other after the gripping portion has passed between the two fixing rollers.

In the aforementioned first and second aspects, preferably, the gripping/conveying means grips with the gripping portion the leading edge of the recording medium which is nipped and conveyed by the fixing roller pair, and the recording medium is conveyed while being pulled by the gripping portion of the gripping/conveying means.

And, preferably, at least one of the two fixing rollers of the fixing roller pair is a heating roller having a heat source within or in a vicinity of a surface thereof.

Further, it is preferable that the gripping/conveying means further comprises: a recording medium gripping stage at which the recording medium is gripped by the gripping portion; a recording medium gripping canceling stage at which gripping of the recording medium by the gripping portion is canceled; and a recording medium conveying stage formed between the recording medium gripping stage and the recording medium gripping canceling stage.

Preferably, the gripping/conveying means includes: a first sprocket pair situated on an upstream side of the fixing roller pair with respect to a conveying direction of the recording medium and arranged at both positions outside both end portions of the fixing roller pair in a direction perpendicular to the conveying direction of the recording medium; a second sprocket pair coaxial with the upper fixing roller and arranged at both positions outside both ends of the upper fixing roller; a third sprocket pair situated on a downstream side of the fixing roller pair with respect to the conveying direction of the recording medium and arranged at positions outside the end portions of the fixing roller pair in a direction perpendicular to the conveying direction of the recording medium; a fourth sprocket pair situated above the first sprocket pair; and chains wrapped around the first sprocket pair, the second sprocket pair, the third sprocket pair, and the fourth sprocket pair, wherein the gripping portion is mounted on the chains perpendicularly to the conveying direction of the recording medium, and grips the leading edge of the recording medium at plural positions.

And, preferably, the gripping/conveying means includes: a first sprocket pair situated on an upstream side of the fixing roller pair with respect to a conveying direction of the recording medium and arranged at both positions outside both end portions of the fixing roller pair in a direction perpendicular to the conveying direction of the recording medium; a second sprocket pair situated on a downstream side of the fixing roller pair with respect to the conveying direction of the recording medium and arranged at both positions outside the both end portions of the fixing roller pair in a direction perpendicular to the conveying direction of the recording medium; and chains wrapped around the first sprocket pair and the second sprocket pair, wherein the gripping portion is mounted on the chains perpendicularly to the conveying direction of the recording medium, and grips the leading edge of the recording medium at plural positions.

And, preferably, the image is formed on the recording medium by using colorant particles containing a colorant and a resin.

Moreover, in order to attain the main object as well as the other object, a third aspect of the present invention provides an image recording apparatus comprising: an image forming device for forming an image on a recording medium by using colorant particles containing a colorant and a resin; and an image fixing device according to the aforementioned first aspect of second aspect.

Here, preferably, the image forming device has an ink jet head which ejects ink including colorant particles containing the colorant to form the image.

And, in order to attain the main object as well as the other object, a fourth aspect of the present invention provides an image fixing method which uses: a fixing roller pair which has two fixing rollers brought into and out of contact with each other and in which the two fixing rollers are brought into contact with each other to cause a recording medium on which an image is formed by using colorant particles containing a colorant and a resin to be nipped between and conveyed by the two fixing rollers thereby fixing the image to the recording medium; roller moving means for moving at least one of the two fixing rollers so that the two fixing rollers of the fixing roller pair are brought into or out of contact with each other; and gripping/conveying means which includes a gripping portion for gripping a leading edge of the recording medium and which conveys the recording medium between the two fixing rollers of the fixing roller pair while gripping the leading edge of the recording medium by the gripping portion, the image fixing method comprising: bringing the two fixing rollers of the fixing roller pair out of contact with each other and gripping the leading edge of recording medium by the gripping portion of the gripping/conveying means before the recording medium passes between the two fixing rollers of the fixing roller pair; bringing the two fixing rollers of the fixing roller pair into contact with each other immediately after the gripping portion for gripping the recording medium has passed between the two fixing rollers; and conveying the recording medium whose leading edge is gripped by the gripping portion, at a conveying speed which is identical to that of the two fixing rollers of the fixing roller pair while pulling the recording medium by the gripping/conveying means.

In the first, second, and fourth aspects of the present invention, it is possible to nip and convey a recording medium with an image formed thereon by the fixing roller pair while gripping the leading edge of the recording medium by the gripping portion, and more preferably, it is possible to convey the recording medium while pulling the same, so that it is possible to reliably separate the recording medium from the fixing roller pair independently of the conveying speed, the fixing conditions, such as the temperature and pressure at the time of image fixing, and the quality and shape of the recording medium, such as the kind of paper (nature of the paper), and the thickness of the paper sheet, making it possible to prevent jamming due to sticking of the recording medium to the fixing roller.

In the third aspect of the present invention, it is possible to nip and convey a recording medium with an image formed thereon while gripping the leading edge of the recording medium by the gripping portion and while pulling the recording medium, so that it is possible to use a highly smoothened fixing roller, whereby it is possible to prevent a reduction in gloss without impairing the quality of the image formed, which is very effective in forming a high-definition/high-quality image.

Further, in the third aspect of the present invention, when a paper material is used for the recording medium, an appropriate tension is applied to this recording medium, so that it is advantageously possible to effectively prevent generation of paper wrinkles, which is likely to be generated when a recording medium formed of a paper material is used.

### BRIEF DESCRIPTION OF THE DRAWINGS

FIG. 1 is a schematic sectional view showing the construction of an image recording apparatus according to an embodiment that is equipped with an image fixing device according to a first aspect of the present invention;

FIG. 2 is a schematic front view, as seen from the right-hand side in the drawing, of a fixing roller pair and the periphery thereof of the image fixing device shown in FIG. 1;

FIG. 3 is a partial side view of a gripper unit according to an embodiment for gripping the leading edge of an image recording medium that is for use in the image fixing device shown in FIG. 1;

FIG. 4 is a schematic side view of a gripper mounting member of the gripper unit shown in FIG. 3, and a claw shaft holder attached to an upper end of a claw base;

FIG. 5 is a partial enlarged view, as seen from the left-hand side of the drawing, of a portion near the lowermost portion of a first sprocket of the image fixing device shown in FIG. 1;

FIG. 6 is a side view schematically showing the way the claw member of the gripper unit shown in FIG. 3 is separated from the claw base;

FIGS. 7A through 7E are schematic diagrams illustrating the operation of the fixing means and the gripping/conveying means in the image fixing device shown in FIG. 1;

FIG. 8 is a schematic sectional view showing the construction of an image recording apparatus according to another embodiment that is equipped with an image fixing device according to the first aspect of the present invention;

FIGS. 9A through 9D are schematic sectional views showing modifications of the fixing roller pair of the image fixing device shown in FIG. 8;

FIGS. 10A and 10B are schematic sectional views showing in detail a cutout portion of the heating roller of the image fixing device shown in FIG. 8;

FIG. 11 is a conceptual drawing schematically showing the construction of an embodiment in which the image recording apparatus shown in FIG. 1 is applied to an electrostatic ink jet recording apparatus;

FIG. 12A is a schematic sectional view of a part of an embodiment of an ejection head of the electrostatic ink jet recording apparatus shown in FIG. 11, and FIG. 12B is a sectional view taken along the arrow line XII-XII of FIG. 12A;

FIG. 13 is a schematic sectional view showing the construction of an image recording apparatus according to an embodiment that is equipped with an image fixing device according to a second aspect of the present invention;

FIG. 14 is a schematic front view, as seen from the right-hand side of the drawing, of a fixing roller pair and the periphery thereof of the image fixing device shown in FIG. 13;

FIGS. 15A through 15E are schematic diagrams illustrating the operation of the fixing means and the gripping/conveying means in the image fixing device shown in FIG. 13;

FIGS. 16A through 16C are schematic diagrams illustrating the operation of an image fixing device according to an embodiment different from the image fixing device shown in FIG. 13; and

FIG. 17 is a conceptual drawing schematically showing the construction of an embodiment in which the image recording apparatus shown in FIG. 13 is applied to an electrostatic ink jet recording apparatus.

### DESCRIPTION OF THE PREFERRED EMBODIMENTS

Preferred embodiments of an image fixing device, an image recording apparatus equipped with the same, and an image fixing method according to the present invention will now be described in detail with reference to the accompanying drawings.

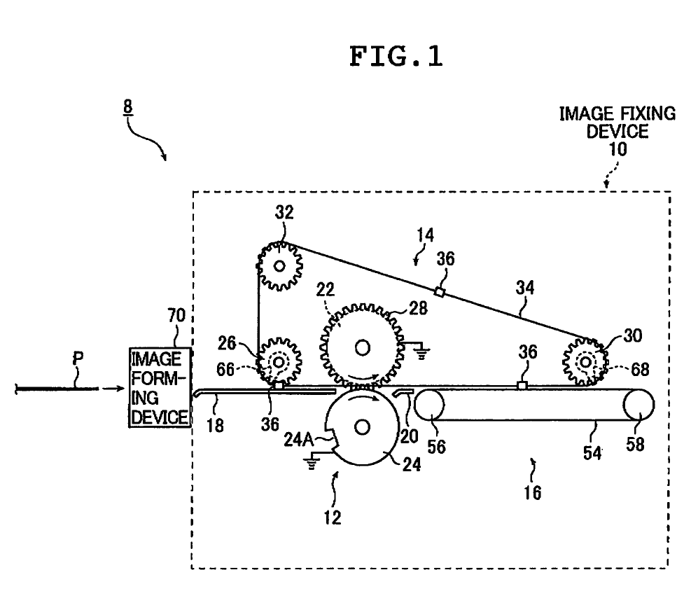

First, an image fixing device according to a first aspect of the present invention, an image recording apparatus according to a third aspect of the present invention equipped with the same, and an image fixing method according to a fourth aspect of the present invention will be described with reference to FIGS. 1 through 12B.

FIG. 1 is a schematic sectional view showing the construction of an embodiment of an image recording apparatus equipped with the image fixing device according to the first aspect of the present invention.

The image recording apparatus 8 shown in FIG. 1 includes an image fixing device 10 and an image forming device 70. Further, the image fixing device 10 includes a fixing roller pair 12, gripping/conveying means 14, belt conveying means 16, a guide plate 18, and a guide plate 20.

Here, the guide plate 18 is provided between the image forming device 70 and the fixing roller pair 12, and guides a recording medium P discharged from the image forming device 70 to the fixing roller pair 12. Also, the guide plate 20 is provided between the fixing roller pair 12 and the belt conveying means 16, and guides the recording medium P discharged from the fixing roller pair 12 to the belt conveying means 16.

As the recording medium P, it is possible to use, without any particular limitations, various types of recording medium including paper such as ordinary paper, woodfree paper, lightweight coated paper, coated paper, art paper, or cast coated paper, or printing film. While there are no particular limitations regarding the shape of the recording medium P, in the embodiment described below, there is used, as a typical example, a rectangular recording medium P generally used.

The image forming device 70 forms an image on the recording medium P by using colorant particles containing a colorant and resin. In the embodiment shown, the image forming device 70 forms an image on the upper surface of the recording medium P conveyed from the left to the right as seen in FIG. 1 by a conveying means (not shown). As the image forming device 70, it is possible to use a device relying on any of various image forming systems (image recording systems). For example, it is possible to utilize a device using any of various types of ink jet system, such as the electrostatic type, thermal type, or piezoelectric type, which use ink including particles (colorant particles) containing a colorant such as pigment and a solvent and in which the ink is ejected by the ink jet system to form an ink image on the recording medium P, and the electrophotographic system in which an image is formed by using toner.

The image fixing device 10 can fix an image formed on the recording medium P by the image forming device 70 by the means and method described below. Here, the conveying path through which the recording medium P is conveyed within the image fixing device 10 is defined by the guide plate 18, the guide plate 20, the gripping/conveying means 14 that will be described later in detail, and the belt conveying means 16 that will be described later in detail. In the following, the image fixing device 10 shown in FIG. 1 will be described in detail.

First, the fixing roller pair 12 constituting the image fixing device 10 will be described.

The fixing roller pair 12 is composed of a pair of fixing rollers, at least one of which is a heating roller having a heat source within or in the vicinity of the roller surface, with the temperature of the roller surface being adjusted to a predetermined value. As shown in FIG. 1, in this embodiment of the present invention, the fixing roller pair 12 is basically composed of a heating roller 22 constituting a first roller, and a pressure roller 24 constituting a second fixing roller. The recording medium P is nipped between and conveyed by the heating roller 22 and the pressure roller 24, whereby heat and pressure are applied to the recording medium P, and the image formed on the recording medium P by the image forming device 70 is fixed.

That is, by the heat of the heating roller 22 and pressing force of the pressure roller 24, the colorant particles on the recording medium P are softened and melted to be firmly attached to the recording medium P, thereby fixing the image. While in this embodiment the heating roller 22 constitutes the first fixing roller, and the pressure roller 24 constitutes the second fixing roller, it is also possible for the pressure roller 24 to constitute the first fixing roller, and for the heating roller 22 to constitute the second fixing roller.

Here, the heating roller 22 contains a heat source, such as a heater or a halogen lamp, and, when performing fixing, is brought into contact with the image recording surface of the recording medium P, making it possible to heat the recording medium P. The heating roller 22 is fixed in rotation axis position, and is rotated by rotary drive means (not shown). It is also possible to adopt a construction in which, when the pressure roller 24 is driven, the heating roller 22 is not driven to rotate but frictionally driven by the rotating pressure roller 24 (That is, it is caused to rotate through friction between its roller surface and the roller surface of the pressure roller 24).

It is desirable for the surfaces of the heating roller 22 and the pressure roller 24 to exhibit superior releasing property; for example, they may be formed of silicone rubber, fluoro rubber, fluororesin or the like, and a releasing agent such as oil may be applied thereto.

As described below, in this embodiment, the configuration of the pressure roller 22 is contrived such that, when the gripper unit 36 passes through the contact portion between the heating roller 22 and the pressure roller 24, the lowermost portion of the heating roller 22 does not come into contact with the gripper unit 36, whereby there is no fear of the gripper unit 36 being strongly brought into contact with the surface of the heating roller 22 to damage the same, and the heating roller 22 can maintain a satisfactory fixing property.

The pressure roller 24 is used for the purpose of pressing the heating roller 22 with a predetermined pressing force at the time of fixing operation. In this embodiment, like the heating roller 22, the pressure roller 24 preferably also contains a heat source, such as a heater or a halogen lamp, serving also as a heating roller for heating the recording medium P at the time of fixing operation. Further, in this embodiment, the pressure roller 24 preferably has a cutout portion 24A constituting a recess according to the present invention forming a “clearance” for avoiding contact of the heating roller 22 and the gripper unit 36. Further, generally speaking, the pressure roller 24 is configured to press the heating roller 22 with a predetermined pressing force uniform in the direction of the roller shaft.

While in this embodiment the pressure roller 24 is a heating roller having, like the heating roller 22, a heat source within or in the vicinity of the surface thereof, it is also possible to heat the recording medium P with the heating roller 22 alone without providing a heat source as described above in the pressure roller. In this case, the pressure roller 24 only functions as a pressure roller for pressing the recording medium P against the heating roller 22. In this embodiment, in order to maintain the correspondence of the gripper unit 36 and the cutout portion 24A, a predetermined torque is imparted to the pressure roller 24.

That is, the pressure roller 24 may, for example, be connected to a rotary drive means connected to the heating roller 22 so as to be rotated in synchronism with the heating roller 22, or it may be connected to a rotary drive means different from that connected to the heating roller 22, and driven to rotate in synchronism such that the peripheral speeds of the two rollers (22 and 24) at the nip portion are the same.

It is desirable for the surfaces of the heating roller 22 and the pressure roller 24 to have superior releasing property; for example, it is desirable to form layers of silicone rubber, fluoro rubber, fluororesin or the like on the surfaces of the cores of the heating roller 22 and the heating roller 24 directly or through other layers.

Further, it is also desirable for the surfaces of the heating roller 22 and the pressure roller 24 to be formed with a surface roughness in terms of Rₐ of 0.05 to 1 μm, whereby it is possible to secure a stable fixing property, making it possible to form an image of a satisfactory quality on the recording medium P.

Further, it is also possible to provide an oil application means for applying oil to at least one of the heating roller 22 and the pressure roller 24, thereby enhancing the separation property for the recording medium. Examples of the oil that can be used include dimethyl siloxane, amino-group-containing dimethyl siloxane, organopolysiloxane, and dimethyl organopolysiloxane, which are used singly or mixed as appropriate at a viscosity of approximately 100 to 1000 (More specifically, it is possible to use KF96 (300 cs) manufactured by Shin-Etsu Chemical Co., Ltd.). Due to this arrangement, it is possible to suppress sticking of the recording medium P to the fixing roller, making it possible to easily separate the recording medium P from the heating roller 22.

Further, it is desirable for the fixing roller pair 12 composed of the heating roller 22 and the pressure roller 24, to have a static elimination means for removing static electricity generated by contact charging, separation charging, friction charging, rolling charging, etc. between the recording medium P and the pair of fixing rollers (the heating roller 22 and the pressure roller 24). In this embodiment, instead of providing such static elimination means, the heating roller 22 and the pressure roller 24 are grounded to effect static elimination on the recording medium P, the heating roller 22, and the pressure roller 24. However, the method of static elimination is not restricted to this, and there is no particular limitation in this regard. For example, it is also possible to use a corona charger, a static eliminator brush, and a static eliminator roller or the like as the static elimination means.

By performing static elimination on the recording medium P, the heating roller 22, and the pressure roller 24 by such static elimination means, it is possible to easily separate the recording medium P from the heating roller 22. Further, it is also possible to combine such static elimination means with an oil application means, thereby further enhancing the separation property for the recording medium.

Here, the surface temperatures of the heating roller 22 and the pressure roller 24, and the pressing force with which the recording medium P is pressed by the pressure roller 24 (the nip pressure between the heating roller 22 and the pressure roller 24) are set as appropriate so that a stable fixing property can be secured. Here, when the conveying speed is high, it is desirable for the surface temperatures to be set high because the fixing time is short; on the other hand, when the conveying speed is low, the fixing time is long; further, when the temperatures are too high, the durability of the rollers deteriorates, and when the temperatures are too low, fixing is deficient. Taking these facts into consideration, the temperatures are preferably 20 to 200° C. and more preferably 70 to 200° C. Further, when the pressing force is too small, deficient fixing and unevenness in fixing occur; on the other hand, when the pressing force is too large, the durability of the rollers deteriorates, and ink particles, colorant particles, etc. are transferred to the rollers. In view of these factors, it is desirable for the pressing force to range from 0.1 to 1 MPa.

The configuration of the pressure roller 24 is characterized in that it provides the requisite “clearance” when the gripper unit 36 of the gripping/conveying means 14 described below passes between the heating roller 22 and the pressure roller 24 (that is, between the two rollers of the fixing roller pair 12). In the following, this “clearance” configuration of the pressure roller 24 will be described.

The pressure roller 24 used in the image fixing device 10 of this embodiment allows smooth passage of the gripper unit 36 at the time of fixing operation of the gripping/conveying means 14 described below. Due to this arrangement, the recording medium P gripped by the gripping/conveying means 14 equipped with the gripper unit 36 can be reliably conveyed along the conveying path.

In the following, the gripping/conveying means 14 constituting the image fixing device 10 will be described.

The gripping/conveying means 14 is capable of gripping the marginal portion, for example, at the leading edge of the recording medium P supplied from the image forming device 70 with the gripper unit 36, and conveying it to the fixing roller pair 12 without touching the image formed by the image forming device 70. Further, the gripping/conveying means 14 is capable of conveying the recording medium P to the exterior or to the next processing step together with the belt conveying means 16 described below while continuing to grip the recording medium P having passed through the nip portion (fixing portion) of the fixing roller pair 12.

The gripping/conveying means 14 shown in FIG. 1 has first sprockets 26, second sprockets 28, third sprockets 30, fourth sprockets 32, chains 34, the gripper unit 36, and cams 66 and 68.

As shown in FIG. 1, the first sprockets 26 are secured in position between the image forming device 70 and the heating roller 22. The second sprockets 28 are coaxial with the heating roller 22 and are arranged on the outer side of the heating roller 22 (see FIG. 2). The third sprockets 30 are secured in position on the downstream side of the fixing roller pair 12 with respect to the conveying direction (from the left to the right in FIG. 1) of the recording medium P. The fourth sprockets 32 are arranged above the first sprockets 26.

The first sprockets 26, the second sprockets 28, and the third sprockets 30, and the fourth sprockets 32 are arranged outside the end portions of the heating roller 22 so as to be contained in the same vertical planes. The chains 34 are endless chains wrapped around the outer peripheries of the first sprockets 26, the second sprockets 28, the third sprockets 30, and the fourth sprockets 32, and successively engaged with the sprockets 26, 28, 30, and 32. Further, provided on the chains 34 are a plurality of, or one, or at least one gripper unit 36.

For its movement in synchronism with the cutout portion 24A of the fixing roller pair 12 (the pressure roller 24), the gripper unit 36 must be arranged at a predetermined position on the chains 34. This will be described in detail below.

As partially shown in FIG. 2, the sprockets 26, 28, 30, and 32 are on each side of the conveying path for the recording medium P, that is, not only on the side as shown in FIG. 1 but also on the opposite side (the front side of the plane of the drawing) in the same construction as shown in FIG. 1. That is, the sprockets 26, 28, 30, and 32 are arranged on each side of the conveying path, and the sprockets arranged on one side are connected to the sprockets arranged on the other side through shaft members.

FIG. 2 is a sectional view as seen in a direction perpendicular to the plane of FIG. 1. As shown in FIG. 2, the shaft members connecting the sprockets are the rotation shafts of the sprockets 26, 28, 30, and 32 (the shaft member of the sprockets 28 also serves as the shaft of the heating roller 22), and the sprocket arranged on one side of each rotation shaft (shaft member) and the sprocket arranged on the other side thereof are capable of perfectly integral rotation.

Further, as shown in FIG. 2, regarding the pressure roller 24, bearings 62 of the pressure roller 24 are pressed upwards from below by springs 64; due to this pressing mechanism, the predetermined pressing force of the pressure roller 24 is applied to the heating roller 22.

Further, arranged on the shaft member connecting the pair of first sprockets 26 are a pair of cams 66 for controlling the operation of the gripping the recording medium P, with the direction of their protrusions being fixed (see FIG. 6). The cams 66 are arranged between the pair of first sprockets 26, with one cam being in the vicinity of each of the first sprockets 26. On the other hand, arranged on the shaft member connecting the third pair of sprockets 30 are a pair of cams 68 for controlling the operation of canceling the gripping of the recording medium P, with the direction of their protrusions being fixed. The cams 68 are arranged between the pair of third sprockets 30, with one cam being near each of the third sprockets 30.

The installation positions of the protrusions of those cams 66 and 68 are determined in advance such that, when the gripper unit 36 grips or releases the recording medium P, a cam roller 50 rotatably supported by an operating arm 48 of the gripper unit 36 is brought into contact with the protrusions of the cams 66 and 68.

As shown in FIG. 1, the first sprockets 26, the third sprockets 30, and the fourth sprockets 32 are adjusted in position such that the heating roller 22 and the second sprockets 28 are reliably arranged within the space surrounded by those sprockets 26, 30, and 32.

That is, the positions of the sprockets 26, 28, 30, and 32 and the position of the heating roller 22 are adjusted such that, when the chains 34 are wrapped around the sprockets 26, 28, 30, and 32, a sufficient space is formed between the portions of the chains 34 stretched from the third sprockets 30 to the fourth sprockets 32, and the heating roller 22 of the fixing roller pair 12 and the second sprockets 28.

It is desirable for the third sprockets 30 to be arranged so as to be spaced apart from the second sprockets 28 by a distance larger than the length of the recording medium P. Due to this arrangement, the recording medium P can be discharged to the exterior of the image fixing device 10 after the image formed on the recording medium P has been completely fixed thereto by the fixing roller pair 12.

Here, the third sprockets 30 (i.e., the shaft thereof) are connected to rotary drive means (not shown), and the torque of the rotary drive means is transmitted to the third sprockets 30. On the other hand, the second sprockets 28 are driven sprockets not connected to any rotary drive means. Although the second sprockets 28 share the same shaft with the heating roller 22, which is a driving roller, they do not rotate in synchronism with the heating roller 22 due to the provision of bearings or the like.

A predetermined tension is imparted to the chains 34 so that power transmission can be reliably effected between the sprockets 26, 28, 30, and 32. Thus, the chains 34 can transmit the torque of the third sprockets 30 equipped with the rotary drive means, to the first sprockets 26, the second sprockets 28, and the fourth sprockets 32. Further, it is desirable, for example, to make the sprockets 32 movable up and down on the plane of FIG. 1, making it possible to adjust the tension of the chains 34.

In the conveying path for the recording medium P from the first sprockets 26 to the third sprockets 30 (see FIG. 1), the gripper unit 36 grips the non-image-recording portion (marginal portion) of the recording medium P, and moves with the movement of the chains 34. As the conveying mechanism (chain/gripper mechanism) for the recording medium P using the chains 34 and the gripper unit 36, it is possible to utilize a conveying mechanism as used for the conveyance of a printing medium in a printing machine or the like. For example, it is possible to use the chain/gripper mechanism provided in the paper feeding mechanism of an offset printing machine disclosed in JP 6-23748 U.

In the image forming device of this embodiment, the chain/gripper mechanism as disclosed in the above-mentioned document can be suitably used with little modification.

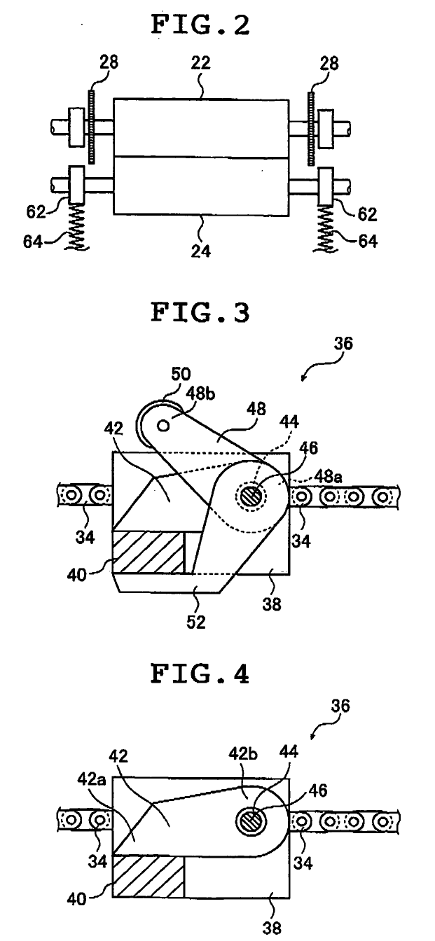

In the following, the chain/gripper mechanism using the gripper unit 36 as used in the image forming device of this embodiment will be described with reference to FIGS. 3 and 4.

FIG. 3 is a partial sectional view (enlarged schematic side view) of the gripper unit 36 as seen from the front side of the plane of FIG. 1, and FIG. 4 is a side view of a gripper mounting member 38 and a pair of claw shaft holders 42 bonded to the upper end of a claw base 40. As shown in FIGS. 3 and 4, the gripper unit 36 basically has a pair of gripper mounting members 38, the claw base 40, the claw shaft holders 42, bearings 44, a claw shaft 46, a pair of operating arms 48, the cam rollers 50, and claw members 52.

The pair of gripper mounting members 38 are installed on the pair of chains 34 so as to be opposed to each other. The claw base 40 is formed as a bar or a plate extending in the direction perpendicular to the plane of the drawing, and the longitudinal end surfaces thereof are bonded to the inner surfaces of the pair of gripper mounting members 38. As shown in FIGS. 3 and 4, the pair of claw shaft holders 42 are bonded to the upper surface of the claw base 40, and are provided at a predetermined interval in the vicinity of the gripper mounting members 38.

As shown in FIG. 4, the bearings 44 are provided at end portions 42b of the claw shaft holders 42 opposite to the end portions 42a bonded to the claw base 40, and the end portions of the claw shaft 46 are engaged with the bearings 44 such that the claw base 40 and the claw shaft 46 are parallel to each other.

As shown in FIG. 3, the pair of operating arms 48 are connected to the claw shaft 46, and the claw shaft 46 is press-fitted into through-holes (bearings) formed in the operating arms 48 and fixed thereto. The installation positions of the pair of operating arms 48 on the claw shaft 46 are between the claw shaft holders 42 and in the vicinity thereof. As shown in FIG; 3, the cam rollers 50 are provided at the end portions 48b, opposite to the end portions 48a, of the operating arms 48 engaged with the claw shaft 46.

Further, a plurality of claw members 52 are arranged at equal intervals on the claw shaft 46 and fixed thereto. The claw shaft 46 is fitted into openings formed in the claw members 52 and is fixed thereto. The claw members 52 are rotatable using the claw shaft 46 as the rotation shaft, and are urged to abut the claw base 40 by an elastic member (not shown). The claw members 52 and the operating arms 48 are fixed to the claw shaft 46, so that the claw members 52 and the operating arms 48 rotate with the rotation of the claw shaft 46. The gripper unit 36 constructed as described above, can grip the recording medium P by holding the recording medium P between the claw base 40 and the claw members 52.

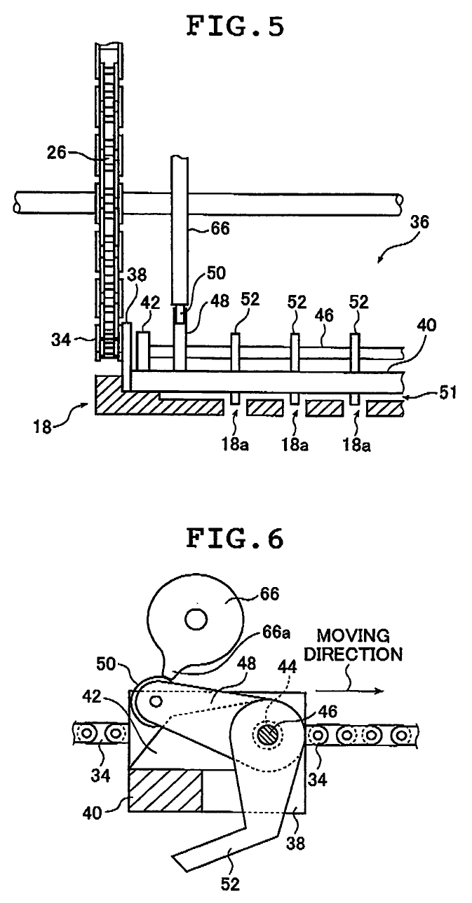

Here, the gripping operation of the gripper unit 36 will be described with reference to FIG. 5. FIG. 5 is a partial sectional view, as seen from the left-hand side of FIG. 1, of the gripper unit 36 passing the lowermost portion of the first sprockets 26 and the periphery thereof.

In FIG. 1, the chains 34 are moved by the torque of the third sprockets 30 having driving means, and upon this movement, the gripper unit 36 attached to the chains 34, also moves. The moving direction is as follows: from the first sprockets 26 to the second sprockets 28; from the second sprockets 28 to the third sprockets 30; and from the third sprockets 30 to the fourth sprockets 32.

The gripper unit 36 moves toward the lowermost portions of the first sprockets 26, with the cam rollers 50 formed at the end portions of the operating arms 48 abutting the cams 66 mentioned above. At this time, the protrusions of the cams 66 abut the cam rollers 50. As a result, the end portions 48b of the operating arms 48 with the cam rollers 50 formed thereon are pushed to approach the claw base 40. Thereupon, the claw shaft 46 to which the operating arms 48 are fixed rotates counterclockwise as seen from the front side of the plane of FIG. 1. Thus, the claw members 52 fixed to the claw shaft 46 also rotate counterclockwise as seen from the front side of the plane of FIG. 1 around the claw shaft 46. That is, the claw members 52 rotate away from the claw base 40.

When, as shown in FIG. 5, the gripper unit 36 reaches the lowermost portions of the first sprockets, the operating arms 48 are held down at the lowermost position by the protrusions 66 of the cams 66. Thus, the claw members 52 of the gripper unit 36 are most spaced apart from the claw base 40 to form a space between the claw members 52 and the claw base 40, enabling the gripper unit 36 to grip the recording medium P. In synchronism with this, the recording medium P is conveyed to a position between the claw members 52 and the claw base 40.

When the gripper unit 36 has passed the lowermost portions of the first sprockets 26, the cam rollers 50 rotatably mounted to the operating arms 48 and the cams 66, which have been in contact with each other, are separated from each other, and the operating arms 48 as shown in FIG. 5 return to the position before the contact with the cams 66. As a result of the return of the claw members 52 to the position where they were in contact with the claw base 40, the recording medium P is gripped.

When the gripper unit 36 passes the lowermost portions of the third sprockets 30, the cams 68 act in the same manner as described above, and the claw members 52 which have been gripping the recording medium P are separated from the claw base 40, so that the gripper unit 36 releases the recording medium P.

Incidentally, the gripper unit 36 grips the recording medium P on the guide plate 18 shown in FIG. 1. During this recording medium gripping operation, there is a fear of the claw members 52 of the gripper unit 36 coming into contact with the guide plate 18 when they are most apart from the claw base 40. As shown in FIG. 5, in this embodiment, to avoid such contact, openings (clearance holes) 18a are formed in the guide plate 18 at positions where the claw members 52 pass. Further, between the claw base 40 and the guide plate 18, there is provided a gap 51 for allowing passage of the recording medium P. Due to the provision of the gap 51, it is possible to convey the recording medium P while reliably gripping it with the gripper unit 36.

Further, grooves are formed at the positions of the guide plates 18 and 20 shown in FIG. 1 where the claw members 52 pass. Due to this construction, it is possible to prevent the claw members 52 from directly coming into contact with the guide plates 18 and 20 during the conveying operation, making the gripper unit 36 unstable and applying an unnecessary load to the gripper unit 36. Thus, a stable conveying operation is possible.

Further, in order for the gripper unit 36 to perform a stable conveyance without involving any deviation or rocking during conveying operation, it is desirable for the guide plates 18 and 20 to be provided, for example at both ends thereof, with grooves for determining the position of the gripper unit 36.

While in this embodiment there is used a gripping means as described above which grips the recording medium P with claw-like members, the present invention is not restricted to such gripping means. It is possible to utilize an arbitrary gripping means as long as it is capable of gripping an end portion of the recording medium P. For example, it is possible to use a means which grips the recording medium by utilizing the magnetic force of a magnet, a means which grips the recording medium by utilizing electrostatic force, or a means which grips the recording medium by piercing the leading edge of the recording medium P with a fine needle-like member. That is, the shape and mechanism of the gripper unit 36 may be arbitrary ones as long as the gripper unit has a function by which it physically nips, pierces, etc., or exerts vacuum suction, etc., and is capable of transmitting to the recording medium P a tension large enough to separate the recording medium P from the fixing rollers.

Further, it is desirable for the components of the gripping means to have a sufficient rigidity and gripping force for separating from the rollers the recording medium which sticks to the fixing rollers during fixing. For example, in the image fixing device shown in FIG. 1, it is desirable to form the claw base 40 and the claw shaft 46 of a rigid material so that the claw base 40 and the claw shaft 46 constituting the gripper unit 36 may not undergo deformation when the recording medium is separated from the heating roller, and it is desirable to determine the urging force, arrangement positions, and number of the claw members 52 such that the recording medium P will not be detached from the gripper unit 36.

Further, while in this embodiment the chains 34 are stretched substantially linearly around the nip portion of the fixing roller pair 12, it is also possible for the passing route of the chains 34 to extend along one of the rollers of the fixing roller pair 12 before or after the nip portion when there is a request for an increase in fixing time, adjustment of the deformation of the recording medium P after the fixing, etc.

Further, as stated above, it is desirable to provide a plurality of gripper units 36 on the chains 34 at intervals corresponding to the conveying interval for the recording medium P. Due to this arrangement, after the completion of the fixing operation on one sheet of the recording medium P, it is possible to successively convey a next sheet of the recording medium P to the fixing roller pair 12, thus conducting a successive and efficient treatment.

Next, the belt conveying means 16 constituting the image fixing device 10 will be described with reference to FIG. 1.

The belt conveying means 16 is capable of conveying with the gripping/conveying means 14 the recording medium P undergoing or having undergone image fixing. Further, the belt conveying means 16 can convey the recording medium P which has undergone conveying operation by the gripping/conveying means 14 to the exterior of the image recording apparatus 8 or to the next step.

The belt conveying means 16 shown in FIG. 1 includes an endless belt 54, a first control roller 56, and a second control roller 58, and is installed in the conveying path on the downstream side of the guide plate 20. The first control roller 56 is provided in portion of the conveying path on the downstream side and in the vicinity of the guide plate 20. The second control roller 58 is provided in the portion of the conveying path on the downstream side of the third sprockets 30. The endless belt 54 is a loop-like recording medium conveying belt wound around the first control roller 56 and the second control roller 58.

Positioning is effected on the belt conveying means 16 such that the upper surface of the endless belt 54 is smoothly connected to the conveying path defined by the guide plate 18 and the guide plate 20.

At least one of the first control roller 56 and the second control roller 58 is connected to rotary drive means (not shown), and the running of the endless belt 54 is controlled by the rotary drive means. Through rotation of the control roller connected to the rotary drive means, the endless belt 54 moves, whereby the belt conveying means 16 can convey the recording medium P. In the case in which both the first control roller 56 and the second control roller 58 are respectively connected to rotary drive means, the driving is effected such that the two rollers exhibit the same peripheral speed.

Here, as stated above, at the lowermost portions of the third sprockets 30, the gripper unit 36 releases the recording medium P, thus ending the gripping operation. At this time, in order that the operation of the claw members 52 may not be hindered, the endless belt 54 is only provided at a position where no claw members 52 pass. That is, the endless belt 54 consists of a plurality of thin endless belts which are wrapped around the control rollers so as to avoid the positions where the claw members 52 pass and which have a width approximately corresponding to the distance between adjacent claw members 52.

Further, the first control roller 56 has peripheral grooves extending around the first control roller 56 at the positions thereof where the claw members 52 pass. Due to this arrangement, it is possible to move the gripper unit 36 smoothly from the guide plate 20 to the belt conveying means 16.

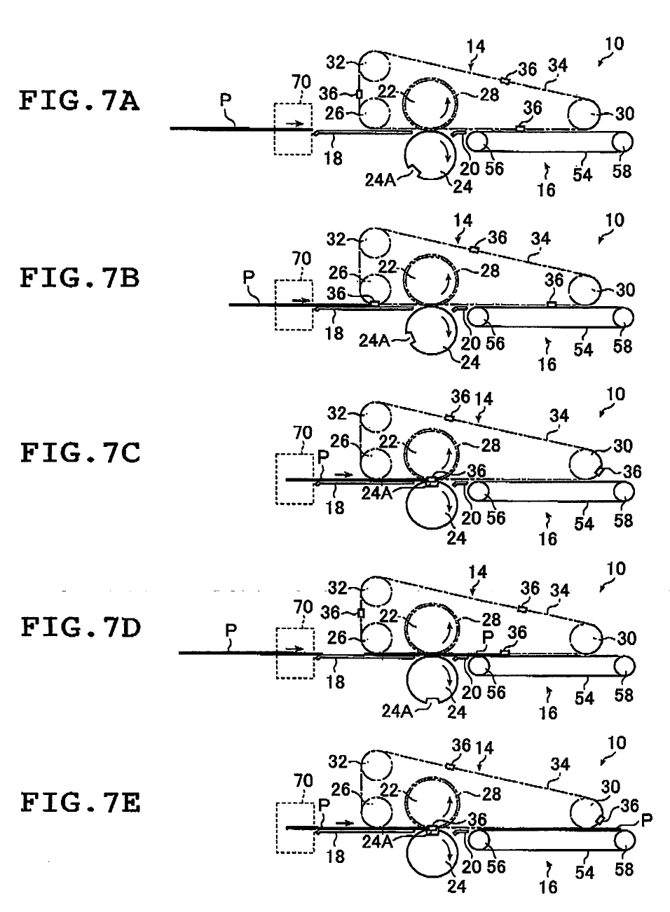

Next, the operation of the image fixing device 10 will be described with reference to FIGS. 7A through 7E. FIGS. 7A through 7E are diagrams illustrating the operation of the fixing roller pair 12, the gripping/conveying means 14, and the belt conveying means 16 of the image fixing device 10.

The chains 34 are moved by the torque of the third sprockets 30, and thereupon, the gripper unit 36 also moves. More specifically, as shown in FIGS. 7A and 7B, the gripper unit 36 moves toward the start point of the conveying path for the recording medium P by the gripping/conveying means 14, that is, toward the lowermost portions of the first sprockets 26. Further, the recording medium P on the surface of which an image has been formed (drawn) by the image forming device 70 is conveyed to the position of the first sprockets 26 of the gripping/conveying means 14 by a conveying means (not shown) while being guided by the guide plate 18.

While passing the lowermost portions of the first sprockets 26, the gripper unit 36 performs gripping operation. Thus, the gripper unit 36 and the recording medium P are moved in synchronism with each other such that, when the gripper unit 36 reaches the lowermost portions of the first sprockets 26, the recording medium P is in a state in which it can be gripped by the gripper unit 36, that is, that the leading edge of the recording medium P is situated between the claw base 40 and the claw members 52.

The gripper unit 36 and recording medium P, moving in synchronism with each other, pass the lowermost portions of the first sprockets 26 simultaneously. At this time, the recording medium P is gripped by the gripper unit 36, and is, as shown in FIGS. 7B and 7C, conveyed to the fixing roller pair 12 with the movement of the chains 34.

Until the recording medium P is conveyed to a position between the claw base 40 and the claw members 52, the gripper unit 36 may remain at rest at the lowermost portions of the first sprockets 26. Further, in this case, it is also possible to provide at the lowermost portions of the first sprockets 26 a detector for detecting the leading edge of the recording medium P, and rotate the third sprockets 30, using the detection result regarding the recording medium P obtained by this detector as a trigger.

In the conceptual drawings of FIGS. 7A through 7E, the recording medium P is depicted as if it is conveyed while extending over both the image forming device 70 and the gripping/conveying means 14. In reality, however, in order that the conveyance of the recording medium P by the gripping/conveying means 14 may not adversely affect the image formation in the image formation apparatus 70, it is desirable to start the conveyance by the gripping/conveying means 14 after the recording medium P has passed the image forming device 70, or to provide a buffer between the image forming device 70 and the gripping/conveying means 14. Further, to prevent interference of the nipping force, etc. of the conveying means, etc. on the upstream side of the gripping/conveying means 14 and to prevent stress load from being applied to the recording medium P, it is desirable for the moving speed of the chains 34 to be equal to the conveying speed of the recording medium P immediately before being gripped by the gripper unit 36.

As shown in FIG. 7C, the recording medium P nipped by the heating roller 22 and the pressure roller 24 is conveyed while undergoing image fixing by the heating roller 22 rotating at a fixed peripheral speed. At this time, it is desirable to control the torque of the third sprockets 30 such that a tension high enough to separate the recording medium P from the heating roller 22 is imparted to the portion between the nip portion where the heating roller 22 and the pressure roller 24 nip the recording medium P and the gripping portion where the gripper unit 36 grips the recording medium P. This makes it possible to pass the recording medium P gripped by the gripper unit 36 through the image fixing portion at a fixed speed and to convey it without allowing it to stick to the heating roller 22.

The chains 34 also continue to move at a fixed speed, and the recording medium P is conveyed at a fixed speed while receiving tension between the nipping portion and the gripping portion where it is gripped by the gripper unit 36. As shown in FIG. 7D, the recording medium P gripped by the gripper unit 36 reaches the belt conveying means 16 while being guided by the guide plate 20. At this time, the moving speed of the endless belt 54 is synchronized with the speed of the recording medium P conveyed by the gripping/conveying means 14, and is adjusted so as not to generate slack in the recording medium P or apply an unnecessarily large load thereto.

The recording medium P is conveyed by the gripping/conveying means 14 and the belt conveying means 16 interlocked with each other to a position where the trailing edge of the recording medium P leaves the heating roller 22. The recording medium P is conveyed as it is, and, immediately after the gripper unit 36 passes the lowermost portions of the third sprockets 30 (the terminal point of the conveying path for gripping/conveyance), the gripper unit 36 releases the recording medium P. And, as shown in FIG. 7E, the recording medium P is conveyed to the exterior or the position for the next step by the belt conveying means 16.

By repeating the above process, it is possible to perform image fixing successively, without allowing the recording mediums P to stick to the heating roller 22.

As shown in FIGS. 7D and 7E, at the moment when the gripper unit 36 gripping and conveying the preceding sheet of the recording medium P passes the fixing roller pair 12, it is possible to start the cycle for inserting the succeeding sheet of the recording medium P into the gap of the fixing roller pair 12.

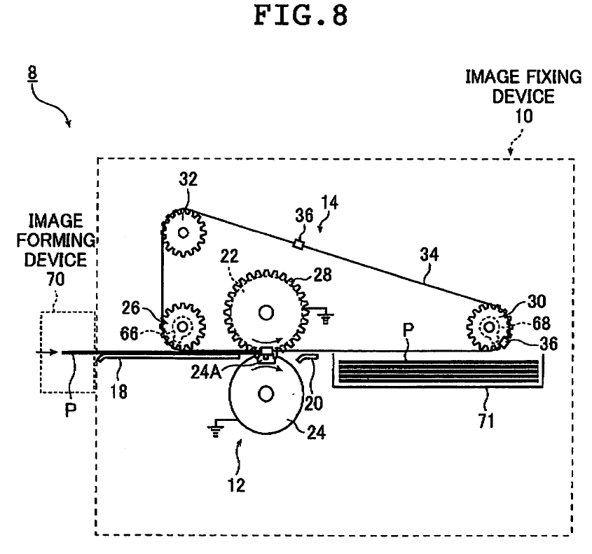

Here, as an embodiment different from the embodiment described above, it is also possible to adopt a form in which, as shown in FIG. 8, there is provided no belt conveying means 16 but is provided instead a sheet discharge tray 71 in which sheets of the recording medium P that have undergone fixing are stacked.

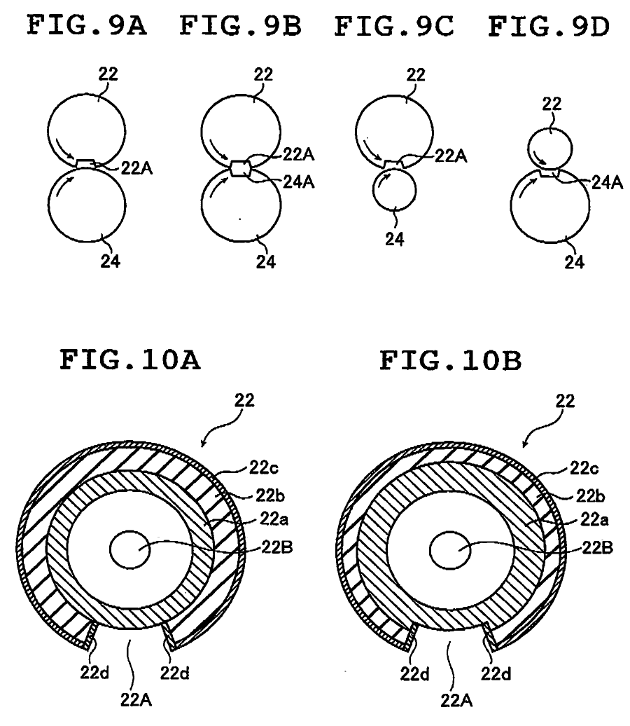

Further, while in the above-described embodiment a construction is adopted in which, of the two rollers constituting the fixing roller pair 12, only the lower, pressure roller 24 is provided with the cutout portion 24A, the present invention is not restricted to this construction; as shown in FIGS. 9A through 9D, various modifications can be adopted.

FIG. 9A shows an example in which, contrary to the above embodiment, of the two rollers constituting the fixing roller pair 12, only the upper, heating roller 22 is provided with a cutout portion 22A, and FIG. 9B shows an example consisting of a combination of these constructions, in which both two rollers constituting the fixing roller pair 12 are provided with the cutout portions 22A and 24A, respectively.

These constructions provide an effect substantially equivalent to that described above. When the construction of FIG. 9B is adopted, the depth of the cutout portions can be made smaller, whereby it is possible to advantageously suppress deformation, etc. of the rollers.

FIGS. 9C and 9D show examples in which similar modifications are realized with constructions in which the diameters of the two rollers constituting the fixing roller pair 12 differ from each other. The reason for making the diameters of the two rollers constituting the fixing roller pair 12 different from each other is, for example, to rectify any upward or downward “warpage” of the recording medium P, in cases where such warpage is likely to be generated. In such cases, the constructions shown here prove effective.

FIGS. 10A and 10B are detailed explanatory views illustrating examples of the construction of the heating roller 22 having the cutout portion 22A.

In the figures, symbol 22a indicates a core formed of aluminum or the like, symbol 22b indicates a predetermined elastic layer, and symbol 22c indicates a releasing layer-formed of silicone rubber, fluoro rubber, fluororesin or the like. Symbol 22d indicates a cover member of the elastic layer 22b, and symbol 22B indicates a heater.

The constructions of FIGS. 10A and 10B differ from each other in the following point: in the example shown in FIG. 10A, a straight aluminum pipe is used as it is as the core 22a, whereas, in the example shown in FIG. 10B, the cutout is also formed in the core 22a.

Due to the provision of the cutout portion 22A (or 24A) structured as described above in the heating roller 22 (or the pressure roller 24), the image fixing device 10 according to this embodiment or the image recording apparatus 8 using the same can exhibit a satisfactory handling property and fixing property for the recording medium P, making it possible to fix an image maintaining a superior image quality and perform formation of such an image.

Next, a more specific embodiment of an image fixing device will be described to explain the effects of the present invention. First, the fixing roller pair 12 shown in FIG. 1 is constructed as follows.

As the heating roller 22 constituting the fixing roller pair 12, there is used a heating roller formed by successively stacking on the surface of a core a silicone rubber elastic layer, a fluoro rubber intermediate layer, and a silicone rubber coating layer. The core is, for example, formed by using an aluminum cylinder having an outer diameter of 214 mm and a thickness of 10 mm, and a heater as a heat source is provided at the center thereof. The silicone rubber elastic layer is formed by using, for example, a silicone rubber having a JIS-A hardness of 10, a thickness of 3 mm, and the fluoro rubber intermediate layer is formed by using, for example, a fluoro rubber having a JIS-A hardness of 70, a thickness of 35 μm. The silicone rubber coating layer is formed by using a silicone rubber having a JIS-A hardness of 70, a thickness of 60 μm, and a surface roughness Rₐ of 0.08 μm.

As the pressure roller 24, there is used a heating/pressure roller formed by successively stacking a silicone rubber elastic layer and a PFA layer on the surface of a core. The core is formed, for example, of an aluminum cylinder having an outer diameter of 218 mm and a thickness of 10 mm, with a heater being provided at the center as a heat source. The silicone rubber elastic layer is formed by using a silicone rubber having a predetermined rubber hardness and thickness, for example, a silicone rubber having a JIS-A hardness of 20, and a thickness of 1 mm, and the perfluoroalkoxy resin (PFA) layer is formed by using a resin having a predetermined thickness and a predetermined surface roughness, which is a PFA having, for example, a thickness of 50 μm and a surface roughness Rₐ of 0.1 μm.

As the recording mediums P to which images are to be fixed, there are used A2 size art paper sheets having three kinds of thickness, for example, 70, 100, and 150 μm (Tokubishi Art (trade name) manufactured by Mitsubishi Paper Mills Co., Ltd.).

On the recording medium P, cyan ink is ejected to a thickness of 1.0 g/m² to form predetermined images. Five seconds to five minutes after the completion of the image formation, the recording medium P is inserted into the gap between the heating roller and the pressure roller, and then image fixing is effected while gripping and conveying the recording medium P by the gripper unit 36.

The nip pressure between the heating roller 22 and the pressure roller 24 is 0.3 MPa, the conveying speed of the recording medium P is 15 mm/sec, and the surface temperature of the heating roller 22 and the pressure roller 24 is 110° C.

In this way, image fixing by the fixing roller pair 12 was conducted a predetermined number of times on recording medium sheets of varying thicknesses, with the result that, in each case, the recording medium sheets could be reliably separated from the heating roller 22 without allowing them to stick to the heating roller 22.

On the other hand, image fixing was conducted by using the above fixing roller pair without using the gripper unit 36, with the result that the recording medium P stuck to the heating roller 22, making it impossible to perform normal fixing processing. In particular, by performing image fixing with the fixing temperature and the nip pressure being adjusted, it was seen that the higher the fixing temperature, and the lower the nip pressure, and the thinner the recording medium P, the higher the possibility of the recording medium P sticking to the heating roller.

Next, the image recording apparatus provided with the image fixing device according to the first aspect of the present invention will be described in detail by way of an embodiment applied to an electrostatic ink jet recording apparatus.

In the following, an example in which colorant particles in ink are positively charged will be described. Contrary to this, the colorant particles in ink that are negatively charged may be used. In this case, the polarity of each component involved in recording may be reversed with respect to that in the following example.

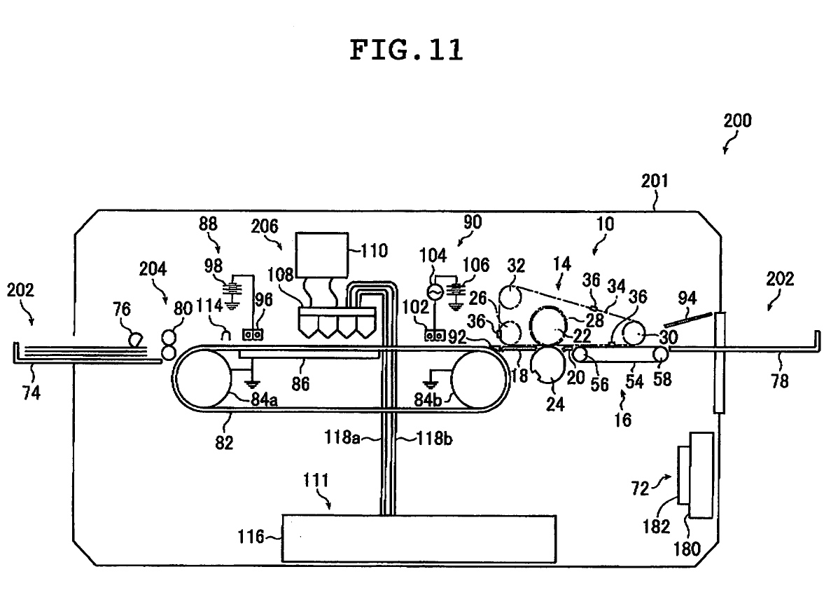

FIG. 11 is a conceptual diagram showing one embodiment of the electrostatic ink jet recording apparatus applying the image recording apparatus of the embodiment under consideration. An ink jet recording apparatus 200 shown in FIG. 11 controls the ejection of ink containing charged colorant particles (charged fine particles) by an electrostatic force, performs 4-color printing on the recording medium P to record a full-color image thereon, and thereafter, fixes the recorded image by contact-heating with a heating roller. The ink jet recording apparatus 200 includes retaining means 202 of the recording medium P, conveying means 204, recording means 206, the image fixing device 10, and solvent collecting means 72, and these components are contained in a casing 201.

In the ink jet recording apparatus 200 shown in FIG. 11, the image fixing device 10 is basically the same as the image fixing device 10 shown in FIG. 1. Therefore, the detailed description of the same components will be omitted here. Furthermore, the recording means 206 in the ink jet recording apparatus 200 in FIG. 11 corresponds to the image forming device 70 in the image recording apparatus 8 in FIG. 1.

First, the retaining means 202 for the recording medium P will be described.

The retaining means 202 includes a sheet feed tray 74 for retaining the recording medium P before recording, a pick-up roller 76, and a sheet discharge tray 78 for retaining the recording medium P after completion of the recording.

The sheet feed tray 74 retains sheets of the recording medium P supplied for recording, and is inserted in the casing 201 from a left side of the casing 201 in FIG. 11. The pick-up roller 76 is placed in the vicinity of a forward end portion (right end portion in FIG. 11) of a mounting portion into which the sheet feed tray 74 is inserted. During recording of an image, the sheets of the recording medium P are taken out one by one from the sheet feed tray 74 by the pick-up roller 76 to be supplied to the conveying means 204 for the recording medium P. In the vicinity of the pick-up roller 76, in order to facilitate the separation of the recording medium P whose sheets are stacked on one another, a static eliminator brush or a static eliminator roller for performing static elimination on the recording medium P, an air blower and the like are preferably provided.

The sheet discharge tray 78 retains the recording medium P on which an image is formed. The sheet discharge tray 78 is provided at the forward end of the conveying path of the recording medium P in the casing 201, and the forward end portion of the tray 78 (forward end side in the conveying direction of the recording medium P) is placed outside the casing 201. The recording medium P after completion of the recording is conveyed by the conveying means 204 to be discharged to the sheet discharge tray 78.

Next, the conveying means 204 for the recording medium P will be described.

The conveying means 204 conveys the recording medium P along a predetermined path from the sheet feed tray 74 to the sheet discharge tray 78, and includes a conveying roller pair 80, a conveying belt 82, belt rollers 84a, 84b, a conductive platen 86, a charger 88 and a static eliminator 90 for the recording medium P, a separation claw 92, and an outlet guide 94. In the section between the separation claw 92 and the outlet guide 94, the gripping/conveying means 14 and belt conveying means 16 of the image fixing device 10 function as the conveying means. As the conveying means 204, in addition to the components shown in FIG. 11, ordinary conveying members such as a conveying roller pair, a conveying belt, and a conveying guide may be arranged as required at appropriate intervals for conveying the recording medium P.

The conveying roller pair 80 is provided at a position between the pick-up roller 76 and the conveying belt 82. The recording medium P taken out of the sheet feed tray 74 by the pick-up roller 76 is nipped in the conveying roller pair 80 and conveyed by the conveying belt 82 to be supplied to a predetermined position on the conveying belt 82.

The conveying belt 82 is a loop-shaped endless belt, and stretched around the two belt rollers 84a, 84b. At least one of the belt rollers 84a, 84b is connected to a driving source (not shown), and rotated at a predetermined speed during recording. Because of this, the conveying belt 82 travels around the belt rollers 84a, 84b clockwise in FIG. 11, and conveys the recording medium P electrostatically attracted to the conveying belt 82 at a predetermined speed.

The surface (front surface) of the conveying belt 82 to which the recording medium P is electrostatically attracted, has an insulating property, and the surface (reverse surface) thereof which is in contact with the belt rollers 84a, 84b has conductivity. Furthermore, on an inner surface side of the conveying belt 82, the conductive platen 86 is placed over a region extending from a position opposed to the charger 88 to a position opposed to an ink jet head 108, and the belt rollers 84a, 84b and the conductive platen 86 are grounded. Because of this, the conveying belt 82 also functions as a counter electrode of the ink jet head 108 at a position opposed to the ink jet head 108.

It is preferable that the conductive platen 86 be placed so that its upper surface slightly protrudes toward the ink jet head 108 side from a line connecting the circumferences of the rollers 84a and 84b. By placing the conductive platen 86 as described above, tension is applied to the conveying belt 82 to suppress flapping.

The charger 88 for the recording medium P includes a scorotron charger 96 and a negative high-voltage source 98. The scorotron charger 96 is placed so as to be opposed to the surface of the conveying belt 82 at a position between the conveying roller pair 80 and the recording means 206 in a conveying path of the recording medium P. Furthermore, the scorotron charger 96 is connected to a terminal on a negative side of the negative high-voltage source 98, and a terminal on a positive side of the negative high-voltage source 98 is grounded.

The surface of the recording medium P is uniformly charged to a predetermined negative high potential by the scorotron charger 96 connected to the negative high-voltage source 98, and a constant DC bias voltage (e.g., about −1.5 kV) required for recording is applied to the surface. Consequently, the recording medium P is electrostatically attracted to the surface of the conveying belt 82 having an insulating property.

The static eliminator 90 for the recording medium P includes a corotron charger 102, an AC voltage source 104, and a high-voltage source 106. The corotron charger 102 is placed so as to be opposed to the surface of the conveying belt 82 on a downstream side of the recording means 206 in the conveying direction of the recording medium P. The corotron charger 102 is connected to the high-voltage source 106 via the AC voltage source 104, and the other terminal of the high-voltage source 106 is grounded.

The recording medium P after the recording is subjected to static elimination by the corotron charger 102, and thereafter, is separated from the conveying belt 82 by the separation claw 92 placed on a downstream side of the corotron charger 102. The recording medium P separated from the conveying belt 82 is conveyed to the image fixing device 10, where the recording medium P is subjected to a fixing process and conveyed by the gripping/conveying means 14 and the belt conveying means 16 to be discharged to the sheet discharge tray 78.

Next, the recording means 206 will be described.

The recording means 206 uses ink containing charged colorant particles, and controls the ejection of ink with an electrostatic force in accordance with image data, thereby recording an image on the recording medium P in accordance with the image data. The recording means 206 includes the electrostatic ink jet head 108, a head driver 110, an ink circulation mechanism 111, and a position detector 114 of the recording medium P.

The ink jet head 108 is placed at a position through which the recording medium P is conveyed by the conveying belt 82 in a stable flat state in the conveying path of the recording medium P in such a manner that its ink ejection portion is positioned at a predetermined distance from the surface of the conveying belt 82 (surface of the recording medium P held on the surface of the conveying belt 82). In the illustrated example, the ink jet head 108 is placed between the rollers 84a and 84b so as to be opposed to the conveying belt 82.

The ink jet head 108 is a line head capable of recording an image of one row simultaneously, and is provided with ejection heads of four colors of cyan (C), magenta (M), yellow (Y), and black (B) for recording a full-color image. The ejection head of each color basically has the same configuration, so that an ejection head 160 of one color will be described below.

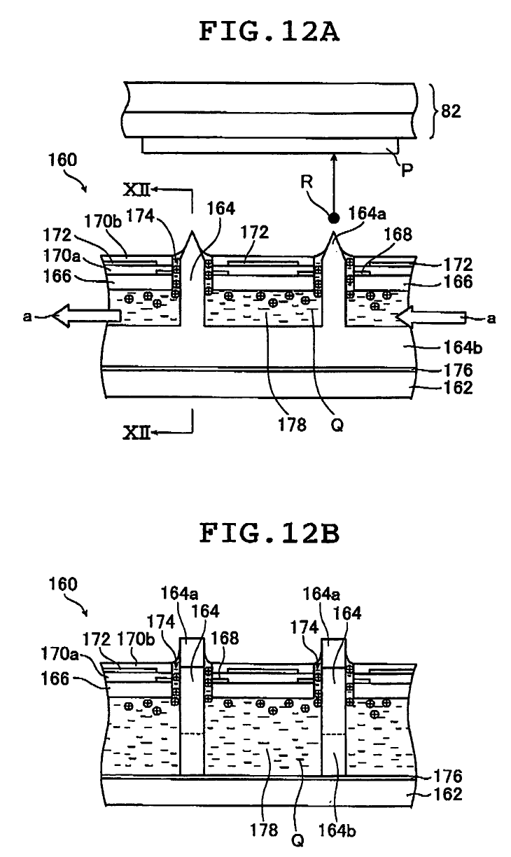

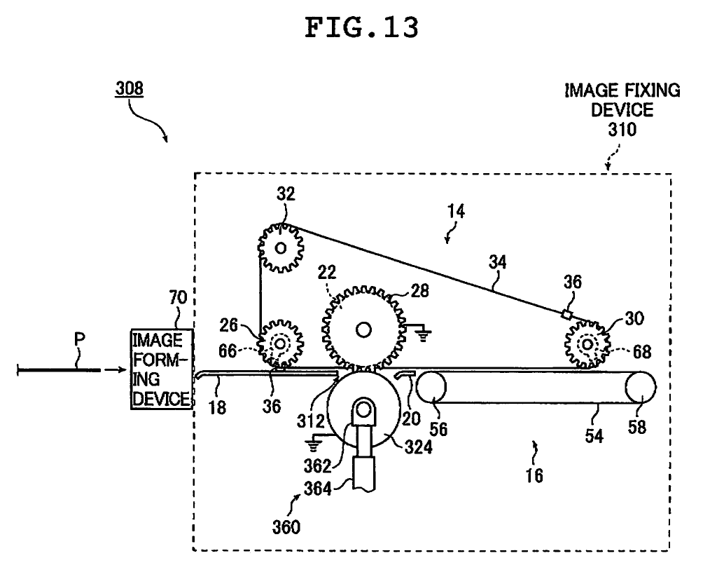

FIGS. 12A and 12B are each schematic view illustrating a specific configuration of the ejection head 160 in the electrostatic ink jet head 108. FIG. 12A is a schematic cross-sectional view showing a part of the ejection head 160, and FIG. 12B is a schematic cross-sectional view taken along the line XII-XII of FIG. 12A.

The ejection head 160 is a multi-channel head provided with nozzles two-dimensionally. Herein, in order to clarify the configuration, only two ejection portions are shown.

The ejection head 160 includes a head substrate 162, ink guides 164, a nozzle substrate 166, ejection electrodes 168, and a floating conductive plate 176. The ejection head 160 is placed so that the tip end of the ink guide 164 as the ejection (flying) point of an ink droplet R is opposed to the conveying belt 82 which supports the recording medium P and serves as a counter electrode.

The head substrate 162 and the nozzle substrate 166 are flat substrates common to all the nozzles of the ejection head 160, and are made of an insulating material. The head substrate 162 and the nozzle substrate 166 are placed at a predetermined distance from each other, and an ink flow path 178 is formed therebetween. Ink Q in the ink flow path 178 contains colorant particles charged to the voltage identical in polarity to that applied to the ejection electrode 168, and during recording, the ink Q is circulated by the ink circulation mechanism 111 (refer to FIG. 11) in the ink flow path 178 at a predetermined speed (e.g., ink flow rate of 200 mm/s) in a predetermined direction, and in the example shown in FIG. 12A, from the right side to the left side (direction indicated by an arrow a in FIG. 12A). Hereinafter, the case where the colorant particles in ink are positively charged will be described.

In the nozzle substrate 166, nozzles 174 serving as ejection ports for the ink Q are formed, and the nozzles 174 are placed two-dimensionally at predetermined intervals. Furthermore, the ink guide 164 for determining the ejection (flying) point of the ink Q is placed in the center of the nozzle 174.

The ink guide 164 is a plate made of an insulating resin with a predetermined thickness, has a protruding tip end portion 164a, and is placed on the head substrate 162 at a position corresponding to each nozzle 174. The ink guide 164 has a base 164b common to the ink guides 164 arranged in the same column (in a horizontal direction in FIG. 12A, and in a direction vertical to the paper surface of FIG. 12B), and the base 164b is fixed on the head substrate 162 with the floating conductive plate 176 interposed therebetween.

Furthermore, the tip end portion 164a of the ink guide 164 is placed so as to protrude from the outermost surface of the ejection head 160 on the recording medium P (conveying belt 82) side. The shape and structure of the tip end portion 164a are set so that the ejection point of the ink Q (ink droplet R) can be stabilized and the ink Q can be sufficiently supplied to the tip end portion 164a, where the colorant particles in the ink Q are concentrated into a preferable state. For example, the tip end portion 164a gradually tapered toward the ejecting direction, the tip end portion 164a in which a slit serving as an ink guide groove is formed in a vertical direction in FIG. 12A, the tip end portion 164a to which a metal is vapor-deposited to substantially increase the dielectric constant of the tip end portion 164a, and the like are preferable.

On the surface (upper surface in FIG. 12A) of the nozzle substrate 166 on the recording medium P side, the ejection electrodes 168 are placed so as to surround the respective nozzles 174. Furthermore, on the recording medium P side of the nozzle substrate 166, an insulating layer 170a covering upper portions (upper surfaces) of the ejection electrodes 168, a sheet-shaped guard electrode 172 placed above the ejection electrodes 168 via the insulating layer 170a, and an insulating layer 170b covering the upper surface of the guard electrode 172 are provided.

The ejection electrodes 168 are placed in a ring shape for each ejection portion (i.e., as circular electrodes) on the upper side of the nozzle substrate 166 in FIG. 12A (i.e., on the surface of the nozzle substrate 166 on the recording medium P side) so as to surround the nozzles 174 formed in the nozzle substrate 166. The ejection electrode 168 is not limited to a circular electrode, and it may be a substantially circular electrode, a divided circular electrode, a parallel electrode, or a substantially parallel electrode.

The ejection electrodes 168 are controlled by the head driver 110, and supplied with a predetermined pulse voltage in accordance with image data. As described above, the recording medium P charged to a voltage opposite in polarity to that of the charged colorant particles in ink is conveyed to a position opposed to the ink guide 164 at a predetermined speed while being held by the conveying belt 82. The recording medium P is charged to a negative high voltage (e.g., −1500 V), and a predetermined electric field which does not cause ejection of the ink Q is formed between the recording medium P and the ejection electrodes 168.

When the ejection electrodes 168 are in an ejection OFF state (ejection stand-by state), a pulse voltage applied is 0V or low. In this state, the electric field intensity in the ejection portion is set by a bias voltage (or a bias voltage superposed on a pulse voltage in the OFF state), which is set lower than the intensity required for ejecting the ink Q, so that the ink Q is not ejected. However, owing to the low electric field in the ejection stand-by state, the colorant particles in ink inside the nozzle 174 are concentrated at the tip end portion 164a of the ink guide 164.

When the ejection electrode 168 is in an ejection ON state, a pulse voltage is applied, and a high pulse voltage (e.g., 400 to 600 V) is superposed on the bias voltage, the electric field intensity of the ejection portion has an intensity sufficient for the ink Q to be ejected, and the ink Q concentrated at the tip end portion 164a of the ink guide 164 flies as the ink droplet R. Since the size of the ink droplet R is very small, a high-quality and high-resolution image can be recorded.

Thus, ON/OFF control is performed on the ejection electrode 168 of each ejection portion arranged over the entire width of the recording medium P in accordance with image data, and ink is ejected at a predetermined timing on the recording medium P conveyed at a predetermined speed, whereby a two-dimensional image is recorded on the recording medium P.

The guard electrode 172 is placed between the ejection electrodes 168 of adjacent ejection portions, and suppresses the interference of an electric field occurring between the ink guides 164 of adjacent ejection portions. The guard electrode 172 is a sheet-shaped electrode such as a metal plate common to all the ejection portions of the ejection head 160, and portions corresponding to the ejection electrodes 168 formed on the periphery of the respective nozzles 174 arranged two-dimensionally are perforated. By providing the guard electrode 172, even in the case where the nozzles 174 are arranged at a high density, the influence of an electric field of the adjacent nozzles 174 can be minimized, and the dot size and the drawing position of a dot can be kept consistently.

On the surface of the head substrate 162 on the ink flow path 178 side, the floating conductive plate 176 is placed. The floating conductive plate 176 is electrically insulated (in a high impedance state). The floating conductive plate 176 generates an induced voltage in accordance with the value of the voltage applied to the ejection portion during image recording, and allows the colorant particles to migrate to the nozzle substrate 166 side in the ink Q flowing in the ink flow path 178. Furthermore, on the surface of the floating conductive plate 176, an electrically insulating coating film (not shown) is formed, whereby the physical properties and components of ink are prevented from becoming unstable due to charge injection into the ink and the like. As the insulating coating film, the one having resistance to corrosion caused by ink can be used.

By providing the floating conductive plate 176, the colorant particles in the ink Q flowing in the ink flow path 178 are allowed to migrate to the nozzle substrate 166 side to increase the concentration of the colorant particles in the ink Q flowing through the nozzles 174 of the nozzle substrate 166 to a predetermined level to concentrate the ink Q at the tip end portion 164a of the ink guide 164, whereby the concentration of the colorant particles in the ink Q to be ejected in the form of the ink droplet R can be stabilized at the predetermined level.

In the illustrated example, the ejection electrodes have a single layer electrode structure. However, the ejection electrodes may have, for example, a two-layer electrode structure which includes first ejection electrodes connected in a column direction and second ejection electrodes connected in a row direction, and in which the first ejection electrodes and the second ejection electrodes are arranged in a matrix to perform matrix driving. According to such a matrix driving system, the higher integration of the ejection electrodes and the simplification of the driver wiring can be realized simultaneously.

The ink circulation mechanism 111 includes an ink tank 116, a pump (not shown), an ink supply path 118a, and an ink recovery path 118b. The ink tank 116 is placed on the inner bottom surface of the casing 201, and is connected to the ink jet head 108 via the ink supply path 118a and the ink recovery path 118b.

The ink tank 116 contains ink of four colors, each of which contains colorant particles of each color and a dispersion solvent for dispersing the colorant particles. The ink of each color in the ink tank 116 is supplied by the pump to the ejection head of each color in the ink jet head 108 via the ink supply path 118a. Furthermore, excessive ink of each color that has not been used for recording an image is recovered to the ink tank 116 for each color via the ink recovery path 118b. The ink tank 116 also contains a dispersion solvent free of colorant particles. The dispersion solvent is used for replenishment of ink for each color and ink concentration adjustment.

Next, the position detector 114 and the head driver 110 constituting the recording means 206 of the ink jet recording apparatus 200 will be described. As shown in FIG. 11, the position detector 114 for the recording medium P is position detecting means such as a photosensor, and is placed so as to be opposed to the surface of the conveying belt 82 by which the recording medium P is conveyed, at a predetermined position (position between the conveying roller pair 80 and the charger 88 in the illustrated example) on an upstream side of the ink jet head 108 in a conveying path of the recording medium P. The positional information on the recording medium P as detected by the position detector 114 is supplied to the head driver 110.

The head driver 110 is a driver of the ink jet head 108, and is connected to the ink jet head 108 via a driving signal cable. In the illustrated example, the head driver 110 is attached to a central upper portion in the casing 201. Image data is input to the head driver 110 from an external apparatus, and the positional information on the recording medium P is input thereto from the position detector 114. While the ejection timing of the ejection head of each color in the ink jet head 108 is controlled in accordance with the positional information on the recording medium P, the ink of each color is ejected from the ejection head for each color in accordance with image data, whereby a full color image corresponding to the image data is recorded on the recording medium P.

In the ink jet recording apparatus 200 shown in FIG. 11, the image fixing device 10 has a construction similar to that of the image fixing device 10 of the image recording device 8 shown in FIG. 1. The image fixing device 10 nips and conveys the recording medium P by the heating roller 22 and the pressure roller 24, thereby heat-fixing an ink image formed on the recording medium P by the recording means 206. Further, when nipping and conveying the recording medium P by the heating roller 22 and the pressure roller 24, the image fixing device 10 causes the leading edge of the recording medium P to be gripped by the gripper unit 36, and conveys the recording medium P while pulling it at the same conveying speed as the conveying speed of the heating roller 22 and the pressure roller 24.

In the image recording apparatus according to this embodiment, the recording medium P is thus gripped by the gripper unit 36, and is conveyed by being pulled, so that the recording medium is prevented from sticking to the heating roller 22, making it possible to reliably convey the recording medium. The surface temperature of the heating roller 22 and the pressing force (nip pressure) provided by the pressure roller 24 toward the recording medium P are set as appropriate so as to secure a desired fixing property and gloss property.

Next, the solvent colleting means 72 of the ink jet recording apparatus 200 will be described.

The solvent collecting means 72 collects a dispersion solvent evaporated from ink ejected from the ink jet head 108 to the recording medium P, a dispersion solvent evaporated from ink during fixing of an image, and the like, and includes an activated carbon filter 180 and an exhaust fan 182. The activated carbon filter 180 is attached to an inner surface of the casing 201, and the exhaust fan 182 is attached onto the activated carbon filter 180.

The air containing dispersion solvent components inside the casing 201 generated by the natural evaporation of the ink solvent from the ink ejected from the ink jet head 108, the natural evaporation of the ink solvent forming an unfixed image on the recording medium P, and the evaporation of the ink solvent generated during fixing by the image fixing device 10 are collected by the exhaust fan 182 and passes through the activated carbon filter 180, whereby the solvent components are removed by being adsorbed to the activated carbon filter 180, and the air with the dispersion solvent components removed therefrom is exhausted to the outside of the casing 201.

Next, the ink Q (ink composition) used in the ink jet head 108 of the ink jet recording apparatus 200 will be described.

In the electrostatic ink jet head 108, the ink Q containing colorant particles (charged fine particles containing colorant) dispersed in a solvent (ink solvent, carrier liquid) is used.

It is preferable that the carrier liquid (ink solvent) be a dielectric liquid (non-aqueous solvent) having a high electric resistivity (10⁹ Ω·cm or more, preferably 10¹⁰ Ω·cm or more). When the carrier liquid having a high electric resistivity is used, it is possible to reduce the possibility that the carrier liquid itself receives charge injection due to the voltage applied by the ejection electrode, whereby the concentration of the charged particles (charged fine particle component) can be increased, and the charged particles can be concentrated. Furthermore, the carrier liquid having a high electric resistivity can also contribute to the prevention of electric conduction between adjacent ejection electrodes. Furthermore, when ink made of liquid having an electric resistivity within the above-mentioned range is used, ink can be ejected satisfactorily even under a low electric field.

The relative permittivity of the dielectric liquid used as the carrier liquid is preferably equal to or smaller than 5, more preferably equal to or smaller than 4, and much more preferably equal to or smaller than 3.5. Such a range is selected for the relative permittivity, whereby the electric field effectively acts on the colorant particles contained in the carrier liquid to facilitate the electrophoresis of the colorant particles.

Note that the upper limit of the specific electrical resistance of the carrier liquid is desirably about 10¹⁶ Ω·cm, and the lower limit of the relative permittivity is desirably about 1.9. The reason why the electrical resistance of the carrier liquid preferably falls within the above-mentioned range is that if the electrical resistance becomes low, then the ejection of the ink droplets under a low electric field becomes worse. Also, the reason why the relative permittivity preferably falls within the above-mentioned range is that if the relative permittivity becomes high, then the electric field is relaxed due to the polarization of the solvent, and as a result the color of dots formed under this condition becomes light, or the bleeding occurs.

Preferred examples of the dielectric liquid used as the carrier liquid include straight-chain or branched aliphatic hydrocarbons, alicyclic hydrocarbons, aromatic hydrocarbons, and the same hydrocarbons substituted with halogens. Specific examples thereof include hexane, heptane, octane, isooctane, decane, isodecane, decalin, nonane, dodecane, isododecane, cyclohexane, cyclooctane, cyclodecane, benzene, toluene, xylene, mesitylene, Isopar C, Isopar E, Isopar G, Isopar H, Isopar L, Isopar M (Isopar: a trade name of EXXON Corporation), Shellsol 70, Shellsol 71 (Shellsol: a trade name of Shell Oil Company), AMSCO OMS, AMSCO 460 Solvent, (AMSCO: a trade name of Spirits Co., Ltd.), a silicone oil (such as KF-96L, available from Shin-Etsu Chemical Co., Ltd.). The dielectric liquid may be used singly or as a mixture of two or more thereof.

For such colorant particles dispersed in the carrier liquid (ink solvent), colorant itself may be dispersed as the colorant particles into the carrier liquid, but dispersion resin particles are preferably contained for enhancement of fixing property. In the case where the dispersion resin particles are contained in the carrier liquid, in general, there is adopted a method in which pigments are covered with the resin material of the dispersion resin particles to obtain particles covered with the resin, or the dispersion resin particles are colored with dyes to obtain the colored particles.

As the color material, pigments and dyes conventionally used in ink compositions for ink jet recording, (oily) ink compositions for printing, or liquid developers for electrostatic photography may be used.

Pigments used as color material may be inorganic pigments or organic pigments commonly employed in the field of printing technology. Specific examples thereof include but are not particularly limited to known pigments such as carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, perinone pigments, thioindigo pigments, quinophthalone pigments, and metal complex pigments.

Preferred examples of dyes used as color material include oil-soluble dyes such as azo dyes, metal complex salt dyes, naphthol dyes, anthraquinone dyes, indigo dyes, carbonium dyes, quinoneimine dyes, xanthene dyes, aniline dyes, quinoline dyes, nitro dyes, nitroso dyes, benzoquinone dyes, naphthoquinone dyes, phthalocyanine dyes, and metal phthalocyanine dyes.

Further, examples of dispersion resin particles include rosins, rosin-modified phenol resin, alkyd resin, a (meth)acryl polymer, polyurethane, polyester, polyamide, polyethylene, polybutadiene, polystyrene, polyvinyl acetate, acetal-modified polyvinyl alcohol, and polycarbonate.

Of those, from the viewpoint of ease for particle formation, a polymer having a weight average molecular weight in a range of 2,000 to 1,000,000 and a polydispersity (weight average molecular weight/number average molecular weight) in a range of 1.0 to 5.0 is preferred. Moreover, from the viewpoint of ease for the fixation, a polymer in which one of a softening point, a glass transition point, and a melting point is in a range of 40° C. to 120° C. is preferred.

In ink Q, the content of colorant particles (total content of colorant particles and dispersion resin particles) preferably falls within a range of 0.5 to 30.0 wt % for the overall ink, more preferably falls within a range of 1.5 to 25.0 wt %, and much more preferably falls within a range of 3.0 to 20.0 wt %. If the content of colorant particles decreases, the following problems become easy to arise. The density of the printed image is insufficient, the affinity between the ink Q and the surface of a recording medium P becomes difficult to obtain to prevent the image firmly stuck to the surface of the recording medium P from being obtained, and so forth. On the other hand, if the content of colorant particles increases, problems occur in that the uniform dispersion liquid becomes difficult to obtain, the clogging of the ink Q is easy to occur in the ink jet head 108 or the like to make it difficult to obtain the stable ink ejection, and so forth.

In addition, the average particle diameter of the colorant particles dispersed in the carrier liquid preferably falls within a range of 0.1 to 2.0 μm, more preferably falls within a range of 0.2 to 1.5 μm, and much more preferably falls within a range of 0.4 to 1.0 μm. Those particle diameters are measured with CAPA-500 (a trade name of a measuring apparatus manufactured by HORIBA LTD.). The average particle diameter of the colorant particles is smaller than that of toner used for dry electrophotography. When the glossiness of an image recorded is not less than 50, the surface of the image becomes flat, thereby exerting adhesion effect, which results in the colorant particles being adhered to the roller easily.

After the colorant particles and optionally a dispersing agent are dispersed in the carrier liquid, a charging control agent is added to the resultant carrier liquid to charge the colorant particles, and the charged colorant particles are dispersed in the resultant liquid to thereby produce the ink Q. Note that in dispersing the colorant particles in the carrier liquid, a dispersion medium may be added if necessary.

As the charging control agent, for example, various ones used in the electrophotographic liquid developer can be utilized. In addition, it is also possible to utilize various charging control agents described in “DEVELOPMENT AND PRACTICAL APPLICATION OF RECENT ELECTRONIC PHOTOGRAPH DEVELOPING SYSTEM AND TONER MATERIALS”, pp. 139 to 148; “ELECTROPHOTOGRAPHY-BASES AND APPLICATIONS”, edited by THE IMAGING SOCIETY OF JAPAN, and published by CORONA PUBLISHING CO. LTD., pp. 497 to 505, 1988; and “ELECTRONIC PHOTOGRAPHY” by Yuji Harasaki, 16(No. 2), p. 44, 1977.

The colorant particles are charged particles identical in polarity to the drive voltages applied to the ejection electrodes 168. The charging amount of the colorant particles is preferably in a range of 5 to 200 μC/g, more preferably in a range of 10 to 150 μC/g, and much more preferably in a range of 15 to 100 μC/g.

In addition, the electrical resistance of the dielectric liquid may be changed by adding the charging control agent in some cases. Thus, the distribution factor P defined below is preferably equal to or larger than 50%, more preferably equal to or larger than 60%, and much more preferably equal to or larger than 70%.
P=100×(σ1−σ2)/σ1
where σ1 is an electric conductivity of the ink Q, and σ2 is an electric conductivity of a supernatant liquid which is obtained by inspecting the ink Q with a centrifugal separator. Those electric conductivities were obtained by measuring the electric conductivities of the ink Q and the supernatant liquid under a condition of an applied voltage of 5 V and a frequency of 1 kHz using an LCR meter of an AG-4311 type (manufactured by ANDO ELECTRIC CO., LTD.) and electrode for liquid of an LP-05 type (manufactured by KAWAGUCHI ELECTRIC WORKS, CO., LTD.). In addition, the centrifugation was carried out for 30 minutes under a condition of a rotational speed of 14,500 rpm and a temperature of 23° C. using a miniature high speed cooling centrifugal machine of an SRX-201 type (manufactured by TOMY SEIKO CO., LTD.).

The ink Q as described above is used, which results in that the colorant particles are likely to migrate and hence the colorant particles are easily concentrated.

The electric conductivity of the ink Q is preferably in a range of 100 to 3,000 pS/cm, more preferably in a range of 150 to 2,500 pS/cm, and much more preferably in a range of 200 to 2,000 pS/cm. The range of the electric conductivity as described above is set, resulting in that the applied voltages to the ejection electrodes are not excessively high, and also there is no anxiety to cause the electrical conduction between the adjacent ejection electrodes.

In addition, the surface tension of the ink Q is preferably in a range of 15 to 50 mN/m, more preferably in a range of 15.5 to 45.0 mN/m, and much more preferably in a range of 16 to 40 mN/m. The surface tension is set in this range, resulting in that the applied voltages to the ejection electrodes are not excessively high, and also the ink does not leak or spread to the periphery of the head to contaminate the head.

Moreover, the viscosity of the ink Q is preferably in a range of 0.5 to 5.0 mPa·sec, more preferably in a range of 0.6 to 3.0 mPa·sec, and much more preferably in a range of 0.7 to 2.0 mPa·sec.

The ink Q can be prepared for example by dispersing colorant particles into a carrier liquid to form particles and adding a charging control agent to the dispersion medium to allow the colorant particles to be charged. The following methods are given as the specific methods.

(1) A method including: previously mixing (kneading) a colorant and optionally dispersion resin particles; dispersing the resultant mixture into a carrier liquid using a dispersing agent when necessary; and adding the charging control agent thereto.

(2) A method including: adding a colorant and optionally dispersion resin particles and a dispersing agent into a carrier liquid at the same time for dispersion; and adding the charging control agent thereto.

(3) A method including adding a colorant and the charging control agent, and optionally the dispersion resin particles and the dispersing agent into a carrier liquid at the same time for dispersion.

Next, with reference to FIGS. 13 through 17, an image fixing device according to a second aspect of the present invention, an image recording apparatus according to the third aspect of the present invention equipped with the same, and an image fixing method according to the fourth aspect of the present invention will be described.

FIG. 13 is a schematic sectional view showing the construction of an embodiment of an image recording apparatus equipped with an image fixing device according to the second aspect of the present invention. The image recording apparatus 308 shown in FIG. 13 is of the same construction as the image recording apparatus 8 shown in FIG. 1 except that, instead of the pressure roller 24 of the image fixing device 10, a pressure roller 324 of an image fixing device 310 and moving means 360 thereof are used. Thus, the same components are indicated by the same reference numerals, and a description thereof will be omitted as appropriate.

The image recording apparatus 308 shown in FIG. 13 includes the image fixing device 310 of the second aspect of the present invention and the image forming device 70. Further, the image fixing device 310 includes a fixing roller pair 312, the gripping/conveying means 14, the moving means 360, the belt conveying means 16, the guide plate 18, and the guide plate 20.

The guide plate 18 is provided between the image forming device 70 and the fixing roller pair 312, and guides the recording medium P discharged from the image forming device 70 to the fixing roller pair 312. The guide plate 20 is provided between the fixing roller pair 312 and the belt conveying means 16, and guides the recording medium P discharged from the fixing roller pair 312 to the belt conveying means 16.

The image fixing device 310 can fix an image formed on the recording medium P by the image forming device 70 by the means and method described below. Here, as in the case of the image fixing device 10 shown in FIG. 1, the conveying path through which the recording medium P is conveyed within the image fixing device 310 is defined by the guide plate 18, the guide plate 20, the gripping/conveying means 14, and the belt conveying means 16. In the following, the image fixing device 310 shown in FIG. 13 will be described in detail.

First, the fixing roller pair 312 constituting the image fixing device 310 will be described.

The fixing roller pair 312 is composed of a pair of fixing rollers, at least one of which is a heating roller having a heat source within or in the vicinity of the roller surface, with the temperature of the roller surface being adjusted to a predetermined value. As shown in FIG. 13, in a preferred embodiment of the present invention, the fixing roller pair 312 is basically composed of the heating roller 22 constituting the first fixing roller, and a pressure roller 324 constituting the second fixing roller. The recording medium P is nipped and conveyed by the heating roller 22 and the pressure roller 324, whereby heat and pressure are applied to the recording medium P, and the image formed on the recording medium P by the image forming device 70 is fixed.

That is, by the heat and pressing force of the heating roller 22 and the pressure roller 324, the colorant particles on the recording medium P are softened and melted to be firmly attached to the recording medium P, thereby fixing the image. While in this embodiment the heating roller 22 constitutes the first fixing roller, and the pressure roller 324 constitutes the second fixing roller, it is also possible for the pressure roller 324 to constitute the first fixing roller, and for the heating roller 22 to constitute the second fixing roller.

The heating roller 22 is provided, with the position of its rotation shaft being fixed, and is rotated by a rotary drive means (not shown). Here, the position of the rotation shaft of the heating roller 22 is adjusted such that the lowermost portion of the heating roller 22 is not brought into contact with the gripper unit 36 when the gripper unit 36 passes between the heating roller 22 and the pressure roller 324. Due to this arrangement, there is no fear of the gripper unit 36 coming into contact with the surface of the heating roller 22 to flaw the same, so that the heating roller 22 can maintain a satisfactory fixing property.

The pressure roller 324 is used for the purpose of pressing the heating roller 22 with a predetermined pressing force at the time of fixing operation. In this embodiment, as a preferred form, the pressure roller 324 also has, within or in the vicinity of its surface, a heat source such as a heater or halogen lamp like the heating roller 22, and functions as a heating roller for heating the recording medium P during fixing operation. The pressure roller 324 is rotated in synchronism with the rotation of the heating roller 22 by a rotary drive means (not shown). Further, at least when the gripper unit 36 passes, the pressure roller 324 is brought by the moving means 360 described below to a position spaced apart from the heating roller 22 by a distance large enough to allow passage of the gripper unit 36. During fixing operation, the pressure roller 324 is caused to advance toward the heating roller 22 by the moving means 360 to abut the heating roller 22. Then, the pressure roller 324 presses the heating roller 22 with a predetermined pressing force uniform in the roller axis direction.

While in this embodiment the pressure roller 324 is a heating roller having, like the heating roller 22, a heat source within or in the vicinity of its surface, it is also possible to heat the recording medium P solely with the heating roller 22, without providing any heat source in the pressure roller. In this case, the pressure roller 324 functions as a roller for pressing the recording medium P against the heating roller 22. In this embodiment, the rotation mechanism and operation of the heating roller 22 and the pressure roller 324 may be the same as those of the heating roller 22 and the pressure roller 24 shown in FIG. 1.

Further, the surface construction and nature of and the surface treatment and static elimination treatment for the heating roller 22 and the pressure roller 324 may also be the same as the surface construction and nature of and the surface treatment and static elimination treatment for the heating roller 22 and the pressure roller 24 shown in FIG. 1. This helps to suppress sticking of the recording medium P to the fixing roller, and to easily separate the recording medium P from the heating roller 22.

Next, the moving means 360 constituting the image fixing device 310 will be described.

At the time of fixing operation, the moving means 360 can cause the pressure roller 324 to advance toward the heating roller 22, bringing the lowermost portion of the roller surface of the heating roller 22 and the uppermost portion of the roller surface of the pressure roller 324 into contact with each other to thereby allow the fixing roller pair 312 (the heating roller 22 and the pressure roller 324) to nip the recording medium P and the pressure roller 324 to press the recording medium P against the heating roller 22. Further, when the gripper unit 36 is about to pass the gap between the fixing roller pair 312, the moving means 360 can bring the pressure roller 324 to a position where it is sufficiently spaced away from the heating roller 22 not to hinder passage of the gripper unit 36 between the heating roller 22 and the pressure roller 324. Due to this arrangement, it is possible to reliably convey along the conveying path, the recording medium P that is gripped by the gripping/conveying means 14 equipped with the gripper unit 36.

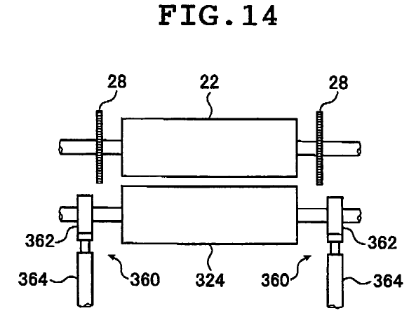

FIG. 14 is a schematic view of the fixing roller pair 312 of FIG. 13 and the periphery thereof as seen from the right-hand side of the plane of the drawing. As shown in FIG. 14, the moving means 360 has bearing units 362 and pneumatic cylinders 364. The bearing units 362 are composed of bearings (not shown) and bearing boxes (not shown) retaining the same, and are connected to the rotation shaft of the pressure roller 324. The pneumatic cylinders 364 are connected to the lower portions of the bearing units 362. Further, the bearing units 362 and the pneumatic cylinders 364 are provided on each axial side of the pressure roller 324 and on the outer sides of the heating roller 22 and the second sprockets 28. The pneumatic cylinders 364 are provided such that the direction in which they expand and contract is perpendicular to the conveying surface on which the recording medium P is conveyed. Due to this arrangement, when the pneumatic cylinders 364 are caused to expand or contract to move the bearing units 362, the pressure roller 324 connected to the bearing units 362 can be moved in the direction perpendicular to the surface on which the recording medium P is conveyed.

The pair of pneumatic cylinders 364 have pressure control means (not shown). This enables the pair of pneumatic cylinders 364 to move the pressure roller 324 such that the lowermost portion of the roller surface of the heating roller 22 and the uppermost portion of the roller surface of the pressure roller 324 are kept parallel to each other. That is, it is possible to move the pressure roller 324 while keeping the rotation shaft of the heating roller 22 parallel to the rotation shaft of the pressure roller 324. Further, the pneumatic cylinders 364 which have the pressure control means can adjust the pressing force of the fixing roller pair 312 to a predetermined pressure.

Here, the surface temperatures of the heating roller 22 and the pressure roller 324, and the pressing force with which the pressure roller 324 presses the recording medium P (the nip pressure between the heating roller 22 and the pressure roller 324) during the fixing operation of this embodiment, are the same as those of the heating roller 22 and the pressure roller 24 shown in FIG. 1.

While this embodiment uses pneumatic cylinders as the power device for moving the pressure roller 324, this should not be construed restrictively; instead of the pneumatic cylinders 364, it is also possible to use a device consisting, for example, of a combination of a motor, a cam mechanism, and a link mechanism.

Incidentally, while in this embodiment the gripper unit 36 is allowed to pass between the heating roller 22 and the pressure roller 324 by moving solely the pressure roller 324 by using the pneumatic cylinders 364, this should not be construed restrictively; as long as the same effect as that of the moving means 360 is obtained, it is also possible to adopt an arrangement in which solely the heating roller 22 is moved, or an arrangement in which both the heating roller 22 and the pressure roller 324 are moved.

The gripping/conveying means 14 used in the image fixing device 310 shown in FIG. 13 is provided for the fixing roller pair 312 composed of the heating roller 22 and the pressure roller 324, while the gripping/conveying means 14 used in the image fixing device 10 shown in FIG. 1 is provided for the fixing roller pair 12 composed of the heating roller 22 and the pressure roller 24. It should be noted, however, that the construction of the gripping/conveying means 14 itself is completely the same in the above two systems. Further, the operation and effect thereof are the same, so a description thereof will be omitted. In the gripping/conveying means 14 used in the image fixing device 10 shown in FIG. 1, the gripper unit 36 on the chains 34 must be arranged at a predetermined position for synchronization with the cutout portion 24A of the pressure roller 24 of the fixing roller pair 12, whereas, in the image fixing device 310 of this embodiment shown in FIG. 13, there are no particular limitations regarding the position of the gripper unit 36 on the chains 34.

It goes without saying that, in this embodiment also, the positions of the first sprockets 26, the third sprockets 30, and the fourth sprockets 32 are adjusted such that the heating roller 22 and the second sprockets 28 are reliably arranged within the space surrounded by those sprockets 26, 30, and 32. That is, the positions of the sprockets 26, 28, 30, and 32 and the position of the heating roller 22 are adjusted such that, when the chains 34 are wrapped around the sprockets 26, 28, 30, and 32, a sufficient space is provided between the portion of the chains 34 stretched from the third sprockets 30 to the fourth sprockets 32 and the heating roller 22 of the fixing roller pair 312, and between that portion of the chains 34 and the second sprockets 28.

It is desirable for the third sprockets 30 to be arranged at a position spaced apart from the second sprockets 28 by a distance larger than the length of the recording medium P. Due to this arrangement, the recording medium P can be discharged to the exterior of the image fixing device 310 after the image formed on the recording medium P has been completely fixed by the fixing roller pair 312.

The belt conveying means 16 used in the image fixing device 310 shown in FIG. 13 conveys the recording medium P which has undergone conveyance by the gripping/conveying means 14 to the exterior of the image recording apparatus 308 or to the position for the next step, while the belt conveying means 16 used in the image fixing device 10 shown in FIG. 1 conveys the recording medium P having undergone conveyance by the gripping/conveying means 14 to the exterior of the image recording device 8 or to the position for the next step. The construction of the belt conveying means 16 in the above two systems, however, is completely the same, and the operation and effect thereof is also the same, so a description thereof will be omitted.

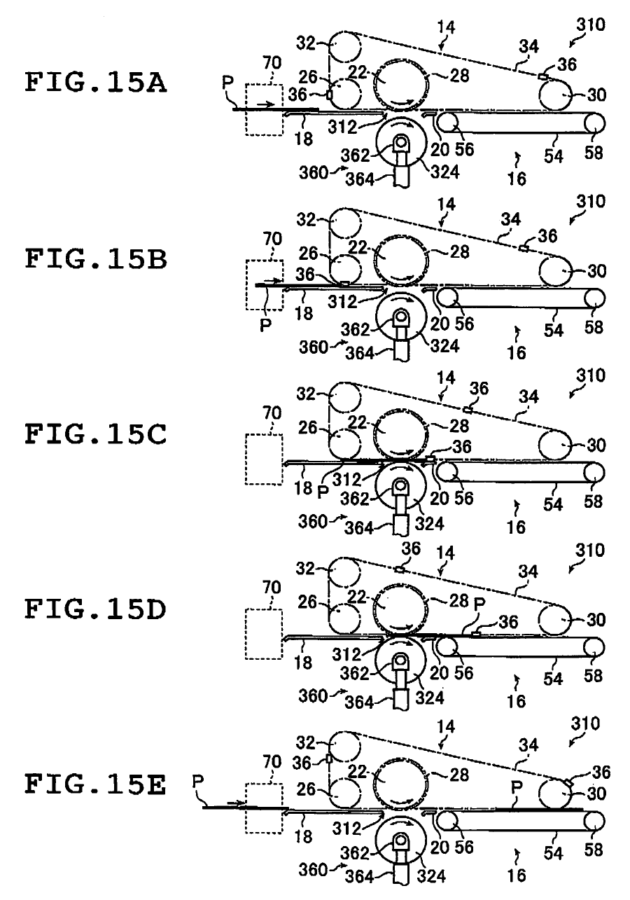

Next, the operation of the image fixing device 310 will be described with reference to FIGS. 15A through 15E. FIGS. 15A through 15E are schematic diagrams illustrating the operation of the fixing roller pair 312, the gripping/conveying means 14, the belt conveying means 16, and the moving means 360 in the image fixing device 310.

The chains 34 are moved by the torque of the third sprockets 30, and thereupon, the gripper unit 36 also moves. As shown in FIG. 15A, the gripper unit 36 moves toward the start point of the path through which the recording medium P is conveyed by the gripping/conveying means 14, that is, in the example shown, toward the lowermost portions of the first sprockets 26. Further, the recording medium P on the surface of which an image has been formed (drawn) by the image forming device 70 is conveyed to the position of the first sprockets 26 of the gripping/conveying means 14 by conveying means (not shown) while being guided by the guide plate 18.

Here, as shown in FIG. 15A, before the recording medium P is subjected to fixing operation, the pressure roller 324 is arranged so as to be spaced apart from the heating roller 22 by a distance large enough not to hinder passage of the gripper unit 36.

Concurrently with the passage through the lowermost portions of the first sprockets 26, the gripper unit 36 performs gripping operation. Thus, the gripper unit 36 and the recording medium P are moved in synchronism with each other such that, when the gripper unit 36 reaches the lowermost portions of the first sprockets 26, the recording medium P is in a state in which it can be gripped by the gripper unit 36, that is, the leading edge of the recording medium P is situated between the claw base 40 and the claw members 52.

The gripper unit 36 and the recording medium P, which are moved in synchronism with each other, pass the lowermost portions of the first sprockets 26 simultaneously. The recording medium P is then gripped by the gripper unit 36, and, as shown in FIG. 15B, is conveyed toward the fixing roller pair 312 with the movement of the chains 34.

It is also possible for the gripper unit 36 to remain at rest at the lowermost portions of the first sprockets 26 until the recording medium P is conveyed to a position between the claw base 40 and the claw members 52. Further, in this case, it is also possible to provide a detector (not shown) for detecting the leading edge of the recording medium P at the lowermost portions of the first sprockets 26, and to rotate the third sprockets 30, using the detection result of the recording medium P obtained by this detector as a trigger.

While in the conceptual drawings of FIGS. 15A through 15E the recording medium P is depicted as if it is conveyed so as to extend over both the image forming device 70 and the gripping/conveying means 14, it is desirable, in reality, to adopt an arrangement in which the conveyance by the gripping/conveying means 14 is started after the recording medium P has passed the image forming device 70, or to provide a buffer between the image forming device 70 and the gripping/conveying means 14 so that the operation of conveying the recording medium P by the gripping/conveying means 14 may not affect the image formation in the image forming device 70. Further, to prevent interference of the nipping force, etc. due to the conveying means, etc. on the upstream side of the gripping/conveying means 14, and to prevent application of a stress load to the recording medium P, it is desirable for the moving speed of the chains 34 to be equal to the conveying speed of the recording medium P immediately before it is gripped by the gripper unit 36.

Next, as shown in FIGS. 15A and 15B, the pressure roller 324 and the heating roller 22 are rotating at the same speed as that of the chains 34 even while they are spaced apart from each other. At this time, the roller temperature is adjusted to the set value. As shown in FIG. 15C, immediately after the gripper unit 36 passes the nipping position where the recording medium P is nipped, the pneumatic cylinders 364 of the moving means 360 operate, and the pressure roller 324 advances toward the heating roller 22. The recording medium P is nipped between the pressure roller 324 having moved and the heating roller 22. The pneumatic cylinders 364 have pressure control means, so that the pressure roller 324 can press the heating roller 22 with a predetermined pressing force (nip pressure). Thus, the fixing of the image formed on the recording medium P is started by the heating roller 22 and the pressure roller 324. Regarding the timing for the start of the operation of the pneumatic cylinders 364 of the moving means 360, the start of the advancement of the pressure roller 324 toward the heating roller 22, the start of the pressing of the heating roller 22 by the pressure roller 324 with a predetermined pressing force, the start of the fixing of the image on the recording medium P, etc., it is possible to make setting such that the operation is started with a previously set timing, or to effect control through provision of timing control means (not shown), or to provide a detector (not shown) for detecting the gripper unit 36, the leading edge of the recording medium P, etc., for example, at the nipping position where the recording medium P is nipped, starting each operation upon reception of a detection signal (trigger signal) from the detector.

The recording medium P nipped by the heating roller 22 and the pressure roller 324 is conveyed while undergoing image fixing by the heating roller 22 and the pressure roller 324 rotating at a fixed peripheral speed. At this time, the gripper unit 36 is pulling the recording medium P at the same speed as the conveying speed of the fixing roller pair 312. The torque of the third sprockets 30 is controlled such that a tension high enough to separate the recording medium P from the heating roller 22 is imparted to the portion between the nipping portion where the heating roller 22 and the pressure roller 324 nip the recording medium P and the gripping portion where the gripper unit 36 grips the recording medium P. Due to this arrangement, it is possible to pass the recording medium P gripped by the gripper unit 36 through the image fixing device at a fixed speed, and to convey it without allowing it to stick to the heating roller 22.

The chains 34 also continue to move at a fixed speed, and the recording medium P is conveyed at a fixed speed while receiving tension between the nipping portion and the gripping portion where it is gripped by the gripper unit 36. As shown in FIG. 15D, the recording medium P gripped by the gripper unit 36 reaches the belt conveying means 16 while being guided by the guide plate 20. At this time, the moving speed of the endless belt 54 is synchronized with the speed of the recording medium P conveyed by the gripping/conveying means 14, and is adjusted so as not to generate slack in the recording medium P or cause an unnecessarily large load to be applied thereto.

The recording medium P is conveyed by the gripping/conveying means 14 and the belt conveying means 16 interlocked with each other to a position where the trailing edge of the recording medium P leaves the heating roller 22. When the recording medium P has passed the fixing roller pair 312, the pneumatic cylinders 364 which have been maintaining a predetermined pressure, operate so as to cause the pressure roller 324 to retract from the heating roller 22. Then, the pneumatic cylinders 364 come to a stop, leaving an interval not hindering passage of the gripper unit 36 between the heating roller 22 and the pressure roller 324. The recording medium P is conveyed as it is, and immediately after the gripper unit 36 passes the lowermost portions of the third sprockets 30 (the terminal of the conveying path for gripping/conveyance), the gripper unit 36 releases the recording medium P. Then, as shown in FIG. 15E, the recording medium P is conveyed to the exterior or to the position for the next step by the belt conveying means 16.

By repeating the above-described process, it is possible to successively fix images without allowing the recording medium P to stick to the heating roller 22.

Incidentally, while the moving means 360 moves only one of the rollers in the fixing roller pair, that is, the pressure roller 324, it is also possible to move solely the heating roller 22, or to move both the heating roller 22 and the pressure roller 324.

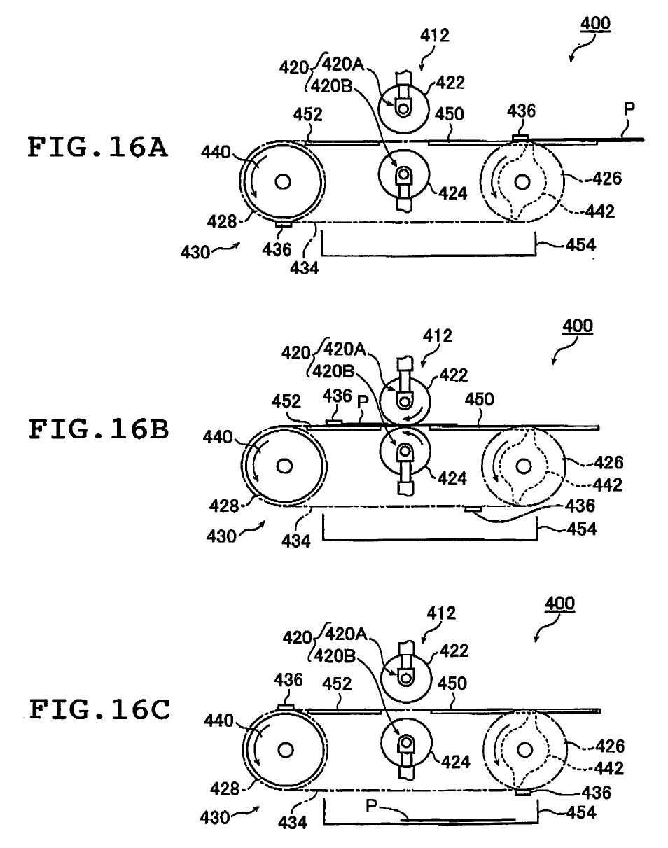

Here, as an embodiment different from the above-described embodiment, there will be described, with reference to FIGS. 16A through 16C, an image fixing device equipped with moving means capable of moving both the heating roller 22 and the pressure roller 324 constituting a fixing roller pair 412.

FIGS. 16A through 16C are schematic diagrams showing the general construction and operation of an image fixing device 400 according to another embodiment. The image fixing device 400 basically has the fixing roller pair 412 as the fixing means, moving means 420, gripping/conveying means 430, a guide plate 450, a guide plate 452, and a sheet discharge tray 454.

The guide plate 450 guides the recording medium P conveyed from an image forming device. (not shown) to the fixing roller pair 412. The guide plate 452 is provided for the purpose of guiding the recording medium P having passed the fixing roller pair 412 to the position of the second sprockets 428.

The fixing roller pair 412 can fix an image formed on the recording medium P by image forming means (not shown). As shown in FIGS. 16A through 16C, the fixing roller pair 412 is composed of a heating roller 422 and a pressure roller 424, with the pair of fixing rollers being arranged vertically one upon the other. Here, the upper roller is the heating roller 422, and the lower roller is the pressure roller 424. The fixing roller pair 412 may be the same as the fixing roller pair 312 shown in FIG. 13. That is, the heating roller 422 and the pressure roller 424 are driving rollers connected to rotary drive means (not shown).

The moving means 420 has heating roller moving means 420A for moving the heating roller 422, and pressure roller moving means 420B for moving the pressure roller 424. The heating roller moving means 420A and the pressure roller moving means 420B can be basically formed by the same mechanism as the moving means 360 described above. By using the heating roller moving means. 420A and the pressure roller moving means 420B, the heating roller 422 and the pressure roller 424 are caused to advance or retract, thereby bring the heating roller 422 and the pressure roller 424 into and out of contact with each other.

Here, as shown in FIGS. 16A through 16C, the gripping/conveying means 430 is composed of first sprockets 426, second sprockets 428, chains 434, a gripper unit 436, a conveying roller 440, and cams 442.

The first sprockets 426 and the second sprockets 428 are arranged such that the fixing roller pair is situated therebetween in the conveying direction, with the chains 434 being wrapped around the first sprockets 426 and the second sprockets 428. The first sprockets 426, the second sprockets 428, and the chains 434 are installed on each side of the conveying path so as to be respectively opposed to each other. The first sprockets 426 provided on each side of the conveying path are connected together by a shaft member, and the second sprockets 428 are also connected together by a shaft member. The shaft members constitute the rotation shafts of the first sprockets 426 and the second sprockets 428, and are arranged parallel to each other.

Here, the second sprockets 428 are connected to rotary drive means (not shown), supplying a torque for the gripping/conveying means 430.

The gripper unit 436 has a mechanism similar to that of the gripper unit 36 shown in FIG. 13. Only, the cams 442 are fixedly provided on the shaft of the first sprockets 426, with the shape of the protrusions of the cams 442 being determined such that the recording medium P is gripped at the uppermost portions of the first sprockets 426 or in the vicinity thereof and released at the lowermost portions thereof or in the vicinity thereof. Further, as shown in FIGS. 16A through 16C, a sheet discharge tray 454 is provided between the first sprockets 426 and the second sprockets 428 and below the same.

As shown in FIG. 16A, the recording medium P with an image formed thereon is conveyed to the uppermost portions of the first sprockets 426 by the guide plate 450 and conveying means (not shown). Here, the recording medium P is gripped by the gripper unit 436 and is conveyed to the fixing roller pair 412. At this time, the heating roller 422 is moved upwards by the heating roller moving means 420A, and the pressure roller 424 is moved downwards by the pressure roller moving means 420B, thereby forming a gap allowing passage of the gripper unit 436 between the heating roller 422 and the pressure roller 424.

As shown in FIG. 16B, after the gripper unit 436 passes the fixing roller pair 412, the moving means 420 operates, and the recording medium P is nipped between the heating roller 422 and the pressure roller 424. In the fixing roller pair 412, the recording medium P is heated by the heating roller 422 and pressed by the pressure roller 424 against the heating roller 422. As a result, the image formed on the recording medium P is fixed. The gripping/conveying means 430 also conveys the recording medium P during image fixing operation, thereby preventing the recording medium P from sticking to the heating roller 422.

The gripping/conveying means 430 conveys the recording medium P having undergone fixing operation to the lowermost portions of the first sprockets 426. As shown in FIG. 16C, when the gripper unit 436 reaches the lowermost portions of the first sprockets 426, the recording medium P is released to complete the conveying operation, and the recording medium P is stacked on the sheet discharge tray 454.

The image fixing device equipped with the moving means capable of moving both the heating roller and the pressure roller has been described above.

Next, a specific embodiment of an image fixing device according to the second aspect of the present invention will be described along with the effects of the present invention.

First, the fixing roller pair 312 shown in FIG. 13 is formed as follows.

As the heating roller 22 constituting the fixing roller pair 312, there is used a heating roller formed by successively stacking on a core a silicone rubber elastic layer, a fluoro rubber intermediate layer, and a silicone rubber coating layer. The core is formed by using an aluminum cylinder having an outer diameter of 55 mm and a thickness of 10 mm, and a heater as a heat source is provided at the center thereof. The silicone rubber elastic layer is formed by using, for example, a silicone rubber having a JIS-A hardness of 10, a thickness of 3 mm, and a surface roughness Rₐ of 10 μm, and the fluoro rubber intermediate layer is formed by using a fluoro rubber having a JIS-A hardness of 70, a thickness of 50 μm, and a surface roughness Rₐ of 0.2 μm. The silicone rubber coating layer is formed by using a silicone rubber having a JIS-A hardness of 70, a thickness of 50 μm, and a surface roughness Rₐ of 0.1 μm.

As the pressure roller 24, there is used a heating/pressure roller formed by successively stacking a silicone rubber elastic layer and a PFA layer on the surface of a core. The core is formed of an aluminum cylinder having an outer diameter of 57 mm and a thickness of 10 mm, with a heater being provided at the center as a heat source. The silicone rubber elastic layer is formed by using a silicone rubber having a predetermined rubber hardness and thickness, for example, a silicone rubber having a JIS-A hardness of 20, and a thickness of 2 mm, and the PFA layer is formed by using a perfluoroalkoxy resin (PFA) having, for example, a thickness of 50 μm, and a surface roughness Rₐ of 0.2 μm.

As the recording mediums P to which images are to be fixed, there are used three kinds of A4 size art paper sheets (Tokubishi Art (trade name) manufactured by Mitsubishi Paper Mills Co., Ltd.).

On the recording medium P as described above, cyan ink is ejected to a thickness of 1.0 g/m² to form predetermined images. After the completion of the image formation, at intervals of 5 seconds to 5 minutes, the recording medium P is inserted into the gap between the heating roller and the pressure roller, and then image fixing is effected while gripping and conveying the recording medium by the gripper unit 36.

The nip pressure between the heating roller 22 and the pressure roller 24 is 0.3 MPa, the conveying speed of the recording medium P is 10 mm/sec, and the surface temperature of the heating roller 22 and the pressure roller 24 is 120° C.

In this way, image fixing by the fixing roller pair 312 was conducted predetermined number of times on recording medium sheets of varying thicknesses, with the result that, in each case, the recording medium sheets could be reliably separated from the heating roller 22 without allowing them to stick to the heating roller 22.

On the other hand, image fixing was conducted by using the above fixing roller pair without using the gripper unit 36, with the result that the recording medium P stuck to the heating roller 22, making it impossible to perform normal fixing processing.

In particular, by performing image fixing with the fixing temperature and the nip pressure being adjusted, it was seen that the higher the fixing temperature, and the higher the nipping pressure, and the thinner the recording medium P, the higher the possibility of the recording medium P sticking to the heating roller.

Next, the image recording apparatus provided with the image fixing device according to the second aspect of the present invention will be described in detail by way of an embodiment applied to an electrostatic ink jet recording apparatus.

In the following, an example in which colorant particles in ink are positively charged will be described. Contrary to this, the colorant particles in ink that are negatively charged may be used. In this case, the polarity of each component involved in recording may be reversed with respect to that in the following example.

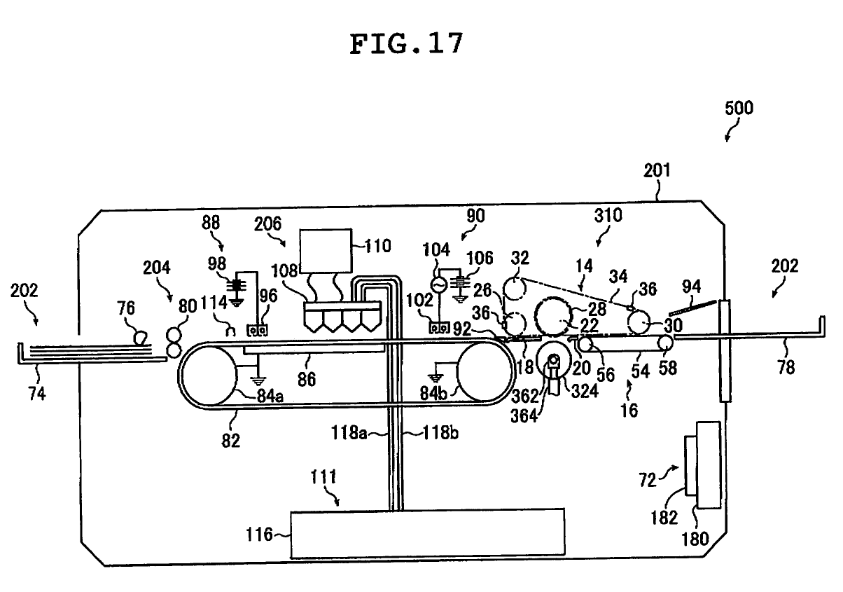

FIG. 17 is a conceptual diagram showing one embodiment of the electrostatic ink jet recording apparatus applying the image recording apparatus of the second embodiment.

An ink jet recording apparatus 500 shown in FIG. 17 is of the same construction as the ink jet recording apparatus 200 shown in FIG. 11 except that, instead of the pressure roller 24 of the image fixing device 10, the pressure roller 324 of the image fixing device 310 and the moving means 360 thereof are used, so the same components are indicated by the same reference numerals, and a description thereof will be omitted as appropriate.

The ink jet recording apparatus 500 shown in FIG. 17 controls the ejection of ink containing charged colorant particles (charged fine particles) by an electrostatic force, performs 4-color printing on the recording medium P to record a full-color image thereon, and thereafter, fixes the recorded image by contact-heating with a heating roller. The ink jet recording apparatus 500 includes the retaining means 202 of the recording medium P, the conveying means 204, the recording means 206, the image fixing device 310, and the solvent collecting means 72, and these components are contained in the casing 201.

In the ink jet recording apparatus 500 shown in FIG. 17, the image fixing device 310 is basically the same as the image fixing device 310 shown in FIG. 13. Therefore, the detailed description of the same components will be omitted here. Furthermore, the recording means 206 in the ink jet recording apparatus 500 in FIG. 17 corresponds to the image forming device 70 in the image recording apparatus 308 in FIG. 13.

The retaining means 202 includes the sheet feed tray 74 for retaining the recording medium P before recording, the pick-up roller 76, and the sheet discharge tray 78 for retaining the recording medium P after completion of the recording.

The retaining means 202 is of the same construction as that described in relation to the embodiment shown in FIG. 1, so a description thereof will be omitted.

The conveying means 204 conveys the recording medium P along a predetermined path from the sheet feed tray 74 to the sheet discharge tray 78, and includes the conveying roller pair 80, the conveying belt 82, the belt rollers 84a, 84b, the conductive platen 86, the charger 88 and the static eliminator 90 for the recording medium P, the separation claw 92, and the outlet guide 94.

The conveying means 204 is also of the same construction as that described in relation to the embodiment shown in FIG. 1, so a description thereof will be omitted.

The recording means 206 uses ink containing charged colorant particles, and controls the ejection of ink with an electrostatic force in accordance with image data, thereby recording an image on the recording medium P in accordance with the image data. The recording means 206 includes the electrostatic ink jet head 108, the head driver 110, the ink circulation mechanism 111, and the position detector 114 of the recording medium P.

The recording means 206 is also of the same construction as that described in relation to the embodiment shown in FIG. 1, so a description thereof will be omitted.

The solvent collecting means 72 of the ink jet recording apparatus 500 is also of the same construction as that described in relation to the embodiment shown in FIG. 1, so a description thereof will be omitted.

Further, regarding the ink (ink composition) used in the ink jet head 108 of the ink jet recording apparatus 500, it is possible to use ink similar to that described in relation to the embodiment shown in FIG. 1, so a description thereof will be omitted.

As stated above, in the ink jet recording apparatus 500 shown in FIG. 17, the image fixing device 310 is of the same construction as the image fixing device 310 of FIG. 13. The image fixing device 310 nips and conveys the recording medium P by the heating roller 22 and the pressure roller 324, thereby heat-fixing an ink image formed on the recording medium P by the recording means 206.

Further, when nipping and conveying the recording medium P by the heating roller 22 and the pressure roller 324, the image fixing device 310 causes the leading edge of the recording medium P to be gripped by the gripper unit 36, conveying the recording medium P while pulling it at a conveying speed which is the same as the conveying speed of the heating roller 22 and the pressure roller 324.

In the image fixing device and the image recording apparatus of this embodiment, the recording medium P is thus gripped by the gripper unit 36, and is conveyed while being pulled. As a result, the recording medium P is prevented from sticking to the heating roller 22, making it possible to reliably convey the recording medium. The surface temperature of the heating roller 22 and the pressing force (nip pressure) with which the recording medium P is pressed by the pressure roller 324 are set as appropriate such that a desired fixing property and gloss can be secured.

The image fixing device, the image recording apparatus equipped therewith, and the image fixing method of the present invention have been explained in detail above, however, the present invention is not restricted to the above-described embodiments and examples, and it goes without saying that various improvements and modifications are possible without departing from the gist of the present invention.

What is claimed is:

1. An image fixing device which fixes an image formed on a recording medium to said recording medium, comprising:
a fixing roller pair which has two fixing rollers in contact with each other and in which said image is fixed to said recording medium being nipped between and conveyed by said two fixing rollers; and
gripping/conveying means which includes a gripping portion for gripping a leading edge of said recording medium and which conveys said recording medium between said two fixing rollers of said fixing roller pair while gripping said leading edge of said recording medium by said gripping portion,
wherein at least one of said two fixing rollers has a recess receiving said gripping portion, and
wherein said at least one of said two fixing rollers is set such that when said leading edge of said recording medium gripped by said gripping portion of said gripping/conveying means is nipped between said two fixing rollers of said fixing roller pair, said gripping portion of said at least one of said two fixing rollers is received by said recess.

2. The image fixing device according to claim 1, wherein said two fixing rollers of said fixing roller pair are arranged vertically, and wherein said recess is formed solely in one of an upper fixing roller or a lower fixing roller of said fixing roller pair.

3. The image fixing device according to claim 1, wherein said two fixing rollers of said fixing roller pair are arranged vertically, and wherein said recess is formed in each of said two fixing rollers.

4. The image fixing device according to claim 1, wherein said gripping/conveying means grips with said gripping portion said leading edge of said recording medium which is nipped and conveyed by said fixing roller pair, and said recording medium is conveyed while being pulled by said gripping portion of said gripping/conveying means.

5. The image fixing device according to claim 1, wherein at least one of said two fixing rollers of said fixing roller pair is a heating roller having a heat source within or in a vicinity of a surface thereof.

6. The image fixing device according to claim 1, wherein said gripping/conveying means further comprises:
a recording medium gripping stage at which said recording medium is gripped by said gripping portion;
a recording medium gripping canceling stage at which gripping of said recording medium by said gripping portion is canceled; and
a recording medium conveying stage formed between said recording medium gripping stage and said recording medium gripping canceling stage.

7. The image fixing device according to claim 1, wherein said gripping/conveying means includes:
a first sprocket pair situated on an upstream side of said fixing roller pair with respect to a conveying direction of said recording medium and arranged at both positions outside both end portions of said fixing roller pair in a direction perpendicular to said conveying direction of said recording medium;
a second sprocket pair coaxial with said upper fixing roller and arranged at both positions outside both ends of said upper fixing roller;
a third sprocket pair situated on a downstream side of said fixing roller pair with respect to said conveying direction of said recording medium and arranged at positions outside said end portions of said fixing roller pair in a direction perpendicular to said conveying direction of said recording medium;
a fourth sprocket pair situated above said first sprocket pair; and
chains wrapped around said first sprocket pair, said second sprocket pair, said third sprocket pair, and said fourth sprocket pair,
wherein said gripping portion is mounted on said chains perpendicularly to said conveying direction of said recording medium, and grips said leading edge of said recording medium at plural positions.

8. The image fixing device according to claim 1, wherein said gripping/conveying means includes:
a first sprocket pair situated on an upstream side of said fixing roller pair with respect to a conveying direction of said recording medium and arranged at both positions outside both end portions of said fixing roller pair in a direction perpendicular to said conveying direction of said recording medium;
a second sprocket pair situated on a downstream side of said fixing roller pair with respect to said conveying direction of said recording medium and arranged at both positions outside said both end portions of said-fixing roller pair in a direction perpendicular to said conveying direction of said recording medium; and
chains wrapped around said first sprocket pair and said second sprocket pair,
wherein said gripping portion is mounted on said chains perpendicularly to said conveying direction of said recording medium, and grips said leading edge of said recording medium at plural positions.

9. The image fixing device according to claim 1, wherein said image is formed on said recording medium by using colorant particles containing a colorant and a resin.

10. An image fixing device which fixes an image formed on a recording medium to said recording medium, comprising:
a fixing roller pair which has two fixing rollers brought into and out of contact with each other and in which said-two fixing rollers are brought into contact with each other to cause said recording medium to be nipped between and conveyed by said two fixing rollers to fix said image to said recording medium;
roller moving means for moving at least one of said two fixing rollers so that said two fixing rollers of said fixing roller pair are brought into or out of contact with each other; and
gripping/conveying means which includes a gripping portion for gripping a leading edge of said recording medium and which conveys said recording medium between said two fixing rollers of said fixing roller pair while gripping said leading edge of said recording medium by said gripping portion,
wherein said roller moving means brings said two fixing rollers of said fixing roller pair out of contact with each other before said gripping portion gripping said leading edge of said recording medium passes between said fixing rollers of said fixing roller pair, and brings said two fixing rollers into contact with each other after said gripping portion has passed between said two fixing rollers.

11. The image fixing device according to claim 10, wherein said gripping/conveying means grips with said gripping portion said leading edge of said recording medium which is nipped and conveyed by said fixing roller pair, and said recording medium is conveyed while being pulled by said gripping portion of said gripping/conveying means.

12. The image fixing device according to claim 10, wherein at least one of said two fixing rollers of said fixing roller pair is a heating roller having a heat source within or in a vicinity of a surface thereof.

13. The image fixing device according to claim 10, wherein said gripping/conveying means further comprises:
a recording medium gripping stage at which said recording medium is gripped by said gripping portion;
a recording medium gripping canceling stage at which gripping of said recording medium by said gripping portion is canceled; and
a recording medium conveying stage formed between said recording medium gripping stage and said recording medium gripping canceling stage.

14. The image fixing device according to claim 10, wherein said gripping/conveying means includes:
a first sprocket pair situated on an upstream side of said fixing roller pair with respect to a conveying direction of said recording medium and arranged at both positions outside both end portions of said fixing roller pair in a direction perpendicular to said conveying direction of said recording medium;
a second sprocket pair coaxial with said upper fixing roller and arranged at both positions outside both ends of said upper fixing roller;
a third sprocket pair situated on a downstream side of said fixing roller pair with respect to said conveying direction of said recording medium and arranged at positions outside said end portions of said fixing roller pair in a direction perpendicular to said conveying direction of said recording medium;
a fourth sprocket pair situated above said first sprocket pair; and
chains wrapped around said first sprocket pair, said second sprocket pair, said third sprocket pair, and said fourth sprocket pair,
wherein said gripping portion is mounted on said chains perpendicularly to said conveying direction of said recording medium, and grips said leading edge of said recording medium at plural positions.

15. The image fixing device according to claim 10, wherein said gripping/conveying means includes:
a first sprocket pair situated on an upstream side of said fixing roller pair with respect to a conveying direction of said recording medium and arranged at both positions outside both end portions of said fixing roller pair in a direction perpendicular to said conveying direction of said recording medium;
a second sprocket pair situated on a downstream side of said fixing roller pair with respect to said conveying direction of said recording medium and arranged at both positions outside said both end portions of said fixing roller pair in a direction perpendicular to said conveying direction of said recording medium; and
chains wrapped around said first sprocket pair and said second sprocket pair,
wherein said gripping portion is mounted on said chains perpendicularly to said conveying direction of said recording medium, and grips said leading edge of said recording medium at plural positions.

16. The image fixing device according to claim 10, wherein said image is formed on said recording medium by using colorant particles containing a colorant and a resin.

17. An image recording apparatus comprising;
an image forming device for forming an image on a recording medium by using colorant particles containing a colorant and a resin; and
an image fixing device which fixes to said recording medium said image formed on said recording medium, said image fixing device including:
a fixing roller pair which has two fixing rollers in contact with each other and in which said image is fixed to said recording medium being nipped between and conveyed by said two fixing rollers; and
gripping/conveying means which includes a gripping portion for gripping a leading edge of said recording medium and which conveys said recording medium between said two fixing rollers of said fixing roller pair while gripping said leading edge of said recording medium by said gripping portion,
wherein at least one of said two fixing rollers has a recess receiving said gripping portion, and
wherein said at least one of said two fixing rollers is set such that when said leading edge of said recording medium gripped by said gripping portion of said gripping/conveying means is nipped between said two fixing rollers of said fixing roller pair, said gripping portion of said at least one of said two fixing rollers is received by said recess.

18. The image recording apparatus according to claim 17, wherein said image forming device has an ink jet head which ejects ink including colorant particles containing said colorant to form said image.

19. An image recording apparatus comprising:
an image forming device for forming an image on a recording medium by using colorant particles containing a colorant and a resin; and
an image fixing device which fixes to said recording medium said image formed on said recording medium, said image fixing device including:
a fixing roller pair which has two fixing rollers brought into and out of contact with each other and in which said two fixing rollers are brought into contact with each other to cause said recording medium to be nipped between and conveyed by said two fixing rollers to fix said image to said recording medium;
roller moving means for moving at least one of said two fixing rollers so that said two fixing rollers of said fixing roller pair are brought into or out of contact with each other; and
gripping/conveying means which includes a gripping portion for gripping a leading edge of said recording medium and which conveys said recording medium between said two fixing rollers of said fixing roller pair while gripping said leading edge of said recording medium by said gripping portion,
wherein said roller moving means brings said two fixing rollers of said fixing roller pair out of contact with each other before said gripping portion gripping said leading edge of said recording medium passes between said fixing rollers of said fixing roller pair, and brings said two fixing rollers into contact with each other after said gripping portion has passed between said two fixing rollers.

20. The image recording apparatus according to claim 19, wherein said image forming device has an ink jet head which ejects ink including colorant particles containing said colorant to form said image.

21. An image fixing method which uses:
a fixing roller pair which has two fixing rollers brought into and out of contact with each other and in which said two fixing rollers are brought into contact with each other to cause a recording medium on which an image is formed by using colorant particles containing a colorant and a resin to be nipped between and conveyed by said two fixing rollers thereby fixing said image to said recording medium;
roller moving means for moving at least one of said two fixing rollers so that said two fixing rollers of said fixing roller pair are brought into or out of contact with each other; and
gripping/conveying means which includes a gripping portion for gripping a leading edge of said recording medium and which conveys said recording medium between said two fixing rollers of said fixing roller pair while gripping said leading edge of said recording medium by said gripping portion, said image fixing method comprising:
bringing said two fixing rollers of said fixing roller pair out of contact with each other and gripping said leading edge of recording medium by said gripping portion of said gripping/conveying means before said recording medium passes between said two fixing rollers of said fixing roller pair;
bringing said two fixing rollers of said fixing roller pair into contact with each other immediately after said gripping portion for gripping said recording medium has passed between said two fixing rollers; and
conveying said recording medium whose leading edge is gripped by said gripping portion, at a conveying speed which is identical to that of said two fixing rollers of said fixing roller pair while pulling said recording medium by said gripping/conveying means.
